(19) United States
(12) Patent Application Publication
(10) Pub. No.: US 2006/0003913 A1
(43) Pub. Date: Jan. 5, 2006

(54) Perfumed liquid laundry detergent compositions with functionalized silicone fabric care agents

(75) Inventors: Jean-Pol Boutique, Gembloux (BE); James Charles Theophile Roger Burckett St. Laurent, Brussels (BE); Hugo Robert Germain Denutte, Hofstade (Aalst) (BE); Connie Lynn Sheets, Cincinnati, OH (US); Patrick Firmin August Delplancke, Laarne (BE); Stefano Scialla, Rome (IT)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 11/170,354

(22) Filed: Jun. 29, 2005

Related U.S. Application Data
(60) Provisional application No. 60/584,043, filed on Jun. 30, 2004.

(51) Int. Cl. C11D 3/00

(52) U.S. Cl. 510/392

(57) ABSTRACT

The invention is directed to aqueous liquid laundry detergent compositions for cleaning and imparting fabric care benefits to fabrics laundered therewith and to methods for preparing such compositions. Such compositions comprise (A) at least one textile-cleaning surfactant; (B) droplets of miscible silicones comprising both a polarly-functionalized, preferably nitrogen-containing amino or ammonium functionalized, polysiloxane component and a nitrogen-free non-functionalized or non-polarly-functionalized polysiloxane component; and (C) a perfume component comprising fragrant aldehydes and/or ketones or a pro-perfume capable of providing such aldheyde and/or ketone perfume materials in situ. Incorporation of a polarly-functionalized polysiloxane fabric care agent into liquid laundry detergent compositions by miscibly combining it with a non-functionalized or non-polarly functionalized polysiloxane minimizes the undesirable interaction such polarly-functionalized silicone material might otherwise have with aldehyde and/or ketone perfume compounds.

### CROSS REFERENCE TO RELATED APPLICATION

This application claims the benefit of U.S. Provisional Application No. 60/584,043 filed on 30 Jun. 2004.

### FIELD OF THE INVENTION

This invention relates to perfumed liquid laundry detergent compositions containing functionalized silicone materials as fabric care agents.

### BACKGROUND OF THE INVENTION

When consumers launder fabrics, they desire not only excellence in cleaning, they also seek to impart superior fabric care benefits via the laundering process. Such fabric care benefits to be imparted can be exemplified by one or more of reduction, prevention or removal of wrinkles; the improvement of fabric softness, fabric feel or garment shape retention or recovery; improved elasticity; ease of ironing benefits; color care; anti-abrasion; anti-pilling; or any combination of such benefits. Detergent compositions which provide both fabric cleaning performance and additional fabric care effects, e.g., fabric softening benefits, are known as “2-in-1”-detergent compositions and/or as “softening-through-the-wash”-compositions.

Due to the incompatibility of anionic detersive surfactants and many cationic fabric care agents, e.g., quaternary ammonium fabric softening agents, in liquid detergent compositions, the detergent industry has formulated alternative compositions which utilize fabric care agents which are not necessarily cationic in nature. One such type of alternative fabric care agents comprises silicone, i.e., polysiloxane-based, materials. Silicone materials include nonfunctional or non-polarly functionalized types such as polydimethylsiloxane (PDMS) and polarly functionalized silicones, and can be deposited onto fabrics during the wash cycle of the laundering process. Such deposited silicone materials can provide a variety of benefits to the fabrics onto which they deposit. Such benefits include those listed hereinbefore.

One specific type of silicones which can provide especially desirable deposition and fabric substantivity improvements comprises the functionalized, nitrogen-containing silicones. These are materials wherein the organic substituents of the silicon atoms in the polysiloxane chain contain one or more amino and/or quaternary ammonium moieties. The terms “amino” and “ammonium” in this context most generally means that there is at least one substituted or unsubstituted amino or ammonium moiety covalently bonded to, or covalently bonded in, a polysiloxane chain and the covalent bond is other than an Si—N bond, e.g., as in the moieties —[Si]—O—CR′₂—NR₃, —[Si]—O—CR′₂—NR₃— [Si]—OCR′₂—N⁺R₄, —[Si]—OCR′₂—N⁺HR₂—[Si]—O—CR′₂—N⁺HR₂—[Si]—CR′₂—NR₃ etc. where —[Si]— represents one silicon atom of a polysiloxane chain. Amino and ammonium functionalized silicones as fabric care and fabric treatment agents are described, for example, in EP-A-150,872; EP-A-577,039; EP-A-1,023,429; EP-A-1,076,129; and WO 02/018528.

Functionalized, nitrogen-containing silicones such as these can be used in and of themselves to impart a certain amount and degree of fabric care benefit. However such functionalized silicones also have shortcomings. For example, it is known that they can react chemically with other components of laundry detergent products. It has now been discovered that a major culprit in deactivating polarly-functionalized silicones and preventing their good working for promoting fabric care is chemical reaction of the polarly-functionalized silicone with certain perfumery ingredients typically used in laundry detergent products to enhance the aesthetic consumer acceptability of such products. Such perfumery ingredients include perfumery aldehydes and/or ketones, or any associated compounds such as pro-perfumes including acetals, ketals, orthoesters, orthoformates, and the like, which are capable of releasing perfume aldehydes and ketones. The chemical reaction between functionalized silicone fabric care agents and aldehyde and/or ketone perfume compounds within the liquid detergent matrix can thus have the undesirable effect of rendering both types of materials less effective in performing their intended beneficial functions within laundry detergent products.

Given the foregoing situation, it would be desirable to provide some means for formulating both types of ingredients into liquid laundry detergent compositions in a manner which can preserve the activity of both ingredients. It would further be desirable to do so without having to resort to the relatively expensive and inconvenient encapsulation or separate packaging of such ingredients. It has now been discovered that by combining ingredients with certain adjuvants in a certain manner and preferably in a certain order, liquid laundry detergent compositions can be formulated in a way which minimizes the chemical interaction between these two types of ingredients. This thus permits their incorporation into such detergent products in a cost-effective manner, resulting in a liquid detergent product wherein each type of ingredient can perform its beneficial function without interference from deactivating interaction with the other ingredient.

### SUMMARY OF THE INVENTION

The present invention is directed to aqueous (e.g., containing upwards of from 4% by weight water) liquid laundry detergent compositions which are suitable for cleaning and imparting fabric care benefits to fabrics laundered using such a composition. Such compositions comprise:
(A) at least 5% of a textile cleaning surfactant component;
(B) at least 0.01% of droplets of a blend of two specific types silicone materials wherein the different silicone types are miscible with in the blend at weight ratios of from 1:100 to 100:1; and
(C) a perfume component comprising a fragrant aldehyde, a fragrant ketone or a mixture thereof or a pro-perfume capable of providing in-situ in the detergent such a fragrant aldehyde, fragrant ketone or mixture thereof.

The blend of silicone materials in the droplets comprises at least a first type of silicone materials which are polarly functionalized and at least a second type of silicone materials which are flowable and unfunctionalized or non-polarly functionalized.

Preferably the polarly functionalized silicones in the silicone blend are amine- or ammonium-group containing functionalized polysiloxanes having a nitrogen content in the range of from 0.001% to 0.5% and a curable-reactive group content, expressed as a molar ratio of curable-reactive group containing silicon atoms to terminal silicon atoms containing no curable-reactive groups, of not more than 0.3. Preferably also the unfunctionalized or non-polarly functionalized silicone is a nitrogen-free polysiloxane material having a viscosity of from 0.01 m²/s to 2.0 m²/s.

Also preferably and optionally, the liquid detergent compositions herein will contain a thickener or structurant for the aqueous phase of the liquid detergent composition. Furthermore, preferably and optionally the liquid detergent compositions herein will contain a coacervating agent, a deposition aid or a mixture thereof and may also optionally contain an ancillary quaternary ammonium softening agent.

The present invention is also directed to a preferred method for preparing an aqueous liquid laundry detergent composition containing both (a) fragrant compounds selected from perfumery aldehydes and ketones and pro-perfumes which can provide such perfumery aldehydes and/or ketones in-situ in such compositions, and (b) fabric care actives comprising silicones having functional groups which can react with such fragrant compounds. Such a method comprises (I) providing functionalized silicone materials selected from aminosilicones, ammonium silicones, substituted ammonium silicones and mixtures thereof, which are miscible with non-functionalized silicones by virtue of these functionalized silicones having a nitrogen content between 0.001% and 0.5%; (II) blending these functionalized silicones with non-functionalized silicones which are fully miscible therewith and which have a viscosity of from 0.01 m²/s to 2.0 m²/s; and (III) combining the product blend of Step II with an aqueous liquid detergent base formulation which comprises at least 4% water, at least 5% of a surfactant, and from 0.00001% to 0.1% of the above-described fragrant compounds such that the final liquid detergent composition comprises discrete droplets of miscible silicones having a mean particle size of no more than 200 microns.

Generally in such a method the functionalized silicones used have a molar ratio of curable/reactive group-containing silicon atoms to terminal silicon atoms containing no curable/reactive groups of not more than 0.3. Preferably also the silicone blend formed via Step II is in the form of an emulsion comprising the combined blend of miscible silicones, water and at least one emulsifier.

### DETAILED DESCRIPTION OF THE INVENTION

The essential and optional components of the liquid laundry detergent compositions herein, as well as composition form, preparation and use, are described in greater detail as follows: In this description, all concentrations and ratios are on a weight basis of the liquid laundry detergent unless otherwise specified. Percentages of certain compositions herein, such as silicone emulsions prepared independently of the liquid laundry detergent, are likewise percentages by weight of the total of the ingredients that are combined to form these compositions. Elemental compositions such as percentage nitrogen (% N) are percentages by weight of the silicone referred to.

Molecular weights of polymers are number average molecular weights unless otherwise specifically indicated. Particle size ranges are ranges of median particle size. For example a particle size range of from 0.1 micron to 200 micron refers to the median particle size having a lower bound of 0.1 micron and an upper bound of 200 microns. Particle size may be measured by means of a laser scattering technique, using a Coulter LS 230 Laser Diffraction Particle Size Analyser from Coulter Corporation, Miami, Fla., 33196, USA.

Viscosity is measured with a Carrimed CSL2 Rheometer at a shear rate of 21 sec⁻¹. Viscosity expressed in m²/sec can be multiplied by 1,000,000 to obtain equivalent values in Centistokes (Cst). Viscosity expressed in Cst can be divided by 1,000,000 to obtain equivalent values in m²/sec. Additionally, Kinematic viscosity can be converted to Absolute viscosity using the following conversion: multiply kinematic viscosity given in centistokes by density (grams/cm³) to get absolute viscosity in centipoise (cp or cps).

All documents cited herein are, in relevant part, incorporated herein by reference. The citation of any document is not to be considered as an admission that it is prior art with respect to the present invention.

A) Surfactants—The present compositions comprise as one essential component at least one textile cleaning surfactant component. Generally the surfactant will be selected from the group consisting anionic surfactants, nonionic surfactants, zwitterionic surfactants, amphoteric surfactants, and combinations thereof. The surfactant component can be employed in any concentration which is conventionally used to effectuate cleaning of fabrics during conventional laundering processes such as those carried out in automatic washing machines in the home. Generally this concentration will be at least 5% by weight. Suitable surfactant component concentrations include those within the range from 5% to 80%, preferably from 7% to 65%, and more preferably from 10% to 45%, by weight of the composition.

Any detersive surfactant known for use in conventional laundry detergent compositions may be utilized in the compositions of this invention. Such surfactants, for example include those disclosed in “Surfactant Science Series”, Vol. 7, edited by W. M. Linfield, Marcel Dekker. Non-limiting examples of anionic, nonionic, zwitterionic, amphoteric or mixed surfactants suitable for use in the compositions herein are described in McCutcheon's, Emulsifiers and Detergents, 1989 Annual, published by M. C. Publishing Co., and in U.S. Pat. Nos. 5,104,646; 5,106,609; 3,929,678; 2,658,072; 2,438,091; and 2,528,378.

Preferred anionic surfactants useful herein include the alkyl benzene sulfonic acids and their salts as well as alkoxylated or un-alkoxylated alkyl sulfate materials. Such materials will generally contain form 10 to 18 carbon atoms in the alkyl group. Preferred nonionic surfactants for use herein include the alcohol alkoxylate nonionic surfactants. Alcohol alkoxylates are materials which correspond to the general formula:
R¹(CₘH₂ₘO)ₙOH
wherein R¹ is a C₈-C₁₆ alkyl group, m is from 2 to 4, and n ranges from about 2 to 12. Preferably R¹ is an alkyl group, which may be primary or secondary, that contains from about 9 to 15 carbon atoms, more preferably from about 10 to 14 carbon atoms. Preferably also the alkoxylated fatty alcohols will be ethoxylated materials that contain from about 2 to 12 ethylene oxide moieties per molecule, more preferably from about 3 to 10 ethylene oxide moieties per molecule.

B) Silicone Component—The present compositions essentially contain droplets of a blend of certain types of silicone materials. This blend of silicone materials comprises both polarly-functionalized silicones and non-functionalized or non-polarly functionalized silicones. Typically, the polarly-functionalized silicone will comprise amino and/or ammonium group-containing functionalized polysiloxane materials. Typically, the non-functionalized or non-polarly functionalized silicone will comprise nitrogen-free, non-functionalized polysiloxane materials. (For purposes of describing this invention, the terms “polysiloxane” and “silicone” can be and are herein used interchangeably.)

Both the polarly-functionalized and non-functionalized or non-polarly functionalized polysiloxanes used in the silicone blend are built up from siloxy units which are chosen from the following groups: 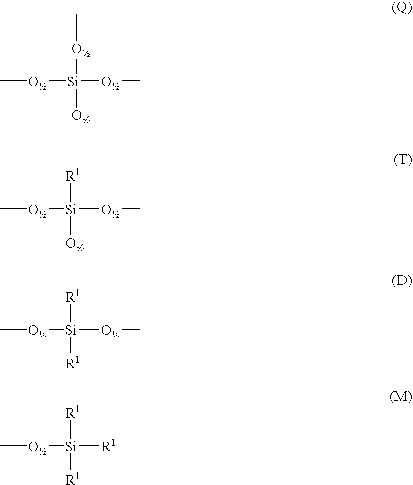
wherein the R¹ substituents represent organic radicals, which can be identical or different from one another. In the amino or ammonium group-containing functionalized polysiloxanes preferably used herein, at least one of the R¹ groups essentially comprises nitrogen in the form of an amino or quaternary moiety, and optionally and additionally may comprise nitrogen in the form of an amide moiety so as to form an amino-amide. In the non-functionalized polysiloxanes preferably used herein, none of the R¹ groups are substituted with nitrogen in the form of an amino or quaternary ammonium moiety.

The R¹ groups for each type of polysiloxanes correspond to those defined more particularly in one or more of the additional general formulas set forth hereinafter for these respective types of polysiloxane materials. However, these Q, T, D and M designations for these several siloxy unit types will be used in describing the preparation of the preferred functionalized polysiloxanes in a manner which minimizes the content of reactive groups in these functionalized materials. These Q, T, D and M designations are also used in describing the NMR monitoring of the preparation of these materials and the use of NMR techniques to determine and confirm reactive group concentrations.

(b1) Functionalized Polysiloxanes:

For purpose of the present invention, the functionalized silicone is a polymeric mixture of molecules each having a straight, comb-like or branched structure containing repeating SiO groups. The molecules comprise functional substituents which comprise at least one polarly-functional moiety, preferably a nitrogen atom, which is not directly bonded to a silicon atom. The functionalized silicones selected for use in the compositions of the present inventions include amino-functionalized silicones, i.e., there are silicone molecules present that contain at least one primary amine, secondary amine, or tertiary amine. Quaternized amino-functionalized silicones, i.e. quaternary ammonium silicones, are also encompassed by the definition of functionalized silicones for the purpose of the present invention. The amino groups can be modified, hindered or blocked in any known manner which prevents or reduces the known phenomenon of aminosilicone fabric care agents to cause yellowing of fabrics treated therewith if, for example, materials too high in nitrogen content are employed.

The functionalized silicone component of the silicone blend will generally be straight-chain, or branched polysiloxane compounds which contain polarly functional, e.g., amino or ammonium, groups in the side groups (i.e., the amino or ammonium groups are present in groups having general structures designated D or T) or at the chain ends (i.e., the amino or ammonium groups are present in groups having general structures designated M). Furthermore, in such functionalized silicones, preferably the molar ratio of curable/reactive group-containing silicon atoms to non-curable/reactive group-containing terminal silicon atoms, e.g., the molar ratio of hydroxyl- and alkoxy-containing silicon atoms to non-hydroxyl- or alkoxy-containing terminal silicon atoms, is from 0% to no more than 30%, i.e., 0.3 mole fraction. This includes, in preferred embodiments, low but non-zero levels that are preferably less than 20%, more preferably less than 10%, more preferably less than 5%, more preferably still, less than 1% Suitably this low level of reactive groups, as determined on the neat (undiluted, not yet formulated) functionalized silicone dissolved at a concentration of, for example, 20% by weight in a solvent such as deuterated chloroform is from about the practical analytical detection threshold (nuclear magnetic resonance) to no more than 30%.

“Hydroxyl- and alkoxy-containing silicon atoms” in this context means all M, D, T and Q groups which contain an Si—OH or Si—OR grouping. (It should be noted that D groups which contain —OH or —OR substituents on the silicon atom will generally comprise the terminal Si atoms of the polysiloxane chain.) The “non-hydroxyl- or alkoxy-containing terminal silicon atoms” means all M groups which contain neither a Si—OH nor a Si—OR group. This molar ratio of hydroxyl- and alkoxy-containing silicon atoms to non-hydroxyl- or alkoxy-containing terminal silicon atoms is expediently determined according to the present invention by nuclear magnetic resonance (NMR) spectroscopy methods, preferably by ¹H-NMR and ²⁹Si-NMR, particularly preferably by ²⁹Si-NMR. According to this invention, this molar ratio of hydroxyl- and alkoxy-containing silicon atoms to non-hydroxyl- or alkoxy-containing terminal silicon atoms is expediently the ratio of the integrals of the corresponding signals in ²⁹ Si-NMR.

The molar ratio used herein can be determined, for example in the case of the functionalized silicone having Formula B hereinafter and where R¹=methyl, aminopropyl and methoxy, from the ratio of the signal integrals (I) at shifts represented by:
−11 ppm (D-OH═(CH₃)₂(HO)SiO—),
−13 ppm (D-OMe═(CH₃)₂(CH₃O)SiO—) and
7 ppm (M═(CH₃)₃SiO—).
Thus the Ratio=(L_{11 ppm}+L_{13 ppm})/I_{7 ppm}×100%. (For purposes of this invention, this molar ratio is expressed as a percentage which is referred to as the percent content of curable/reactive groups in the functionalized silicone.)

For other alkoxy groupings, such as, for example, ethoxy, signals in the ²⁹Si-NMR can be assigned accordingly. The NMR practitioner is readily able to assign the corresponding chemical shifts for differently substituted siloxy units. It is also possible to use the ¹H-NMR method in addition to the ²⁹Si-NMR method. A suitable set of NMR conditions, procedures and parameters is set forth in the Examples hereinafter. Infra-red spectroscopy can also be used.

According to the invention, it is furthermore preferable that not only is the molar ratio of hydroxyl- and alkoxy-containing silicon atoms to non-hydroxyl- or alkoxy-containing terminal silicon atoms less than 20%, but also the molar ratio of all the silicon atoms carrying reactive groups to the non-reactive M groups is less than 20%. The limit value of 0% in the context of the invention means that preferably silicon atoms containing reactive groups can no longer be detected by suitable analytical methods, such as NMR spectroscopy or infra-red spectroscopy. It should be noted that, in view of the preparative methods for the functionalized silicone materials, having no reactive groups or having them at very limited levels does not follow automatically from mere presentation of chemical structures not having such reactive groups. Rather, reactive group content must be practically secured at the specified levels by adapting the synthesis procedure for these materials, as is provided for herein.

In the context of preferred embodiments of this invention, non-reactive chain-terminating M groups represent structures which, in the environment of the detergent formulations herein, are not capable of forming covalent bonds with a resulting increase in the molecular weight of materials formed. In such non-reactive structures, the substituents R¹ include, for example, Si—C-linked alkyl, alkenyl, alkynyl and aryl radicals, which optionally can be substituted by N, O, S and halogen. The substituents are preferably C₁ to C₁₂ alkyl radicals, such as methyl, ethyl, vinyl, propyl, isopropyl, butyl, hexyl, cyclohexyl and ethylcyclohexyl.

In the context of the invention, M, D, T and Q structures with curable/reactive groups mean and represent, in particular, structures which do not contain the polarly functional, e.g., amino or quaternary nitrogen, moieties and which, in the environment of the detergent formulations herein, are capable of forming covalent bonds, thereby creating material of increased molecular weight or interacting with the aldehyde or ketone moieties of the perfume component. In such structures, the predominant curable/reactive units are the Si—OH and SiOR units as mentioned, and can furthermore also include epoxy and/or ≡SiH and/or acyloxysilyl groups, and/or Si—N—C-linked silylamines and/or Si—N—Si-linked silazanes. Examples of alkoxy-containing silicon units are the radicals ≡SiOCH₃, ≡SiOCH₂CH₃, ≡SiOCH(CH₃)₂, ≡SiOCH₂CH₂CH₂CH₃ and ≡SiOC₆H₅. An example of an acyloxysilyl radical is ≡SiOC(O)CH₃. For silylamine groups, ≡SiN(H)CH₂CH═CH₂ may be mentioned by way of example, and for silazane units ≡SiN(H)Si(CH₃)₃.

The functionalized silicones used herein and having the preferred low levels of reactive groups can be prepared by a process which involves:
i) hydrolysis of alkoxysilanes or alkoxysiloxanes;
ii) catalytic equilibration and condensation; and
iii) removal of the condensation products from the reaction system, for example with anentraining agent such as an inert gas flow.

Using this combined hydrolysis/equilibration process, the preferred functionalized silicones herein can be prepared for example, on the one hand from organofunctional alkoxysilanes or alkoxysiloxanes, and on the other hand with non-functional alkoxysilanes or alkoxysiloxanes. Instead of the organofunctional alkoxysilanes or the non-functional alkoxysilanes, other silanes containing hydrolysable groups on the silicon, such as, for example, alkylaminosilanes, alkylsilazanes, alkylcarboxysilanes, chlorosilanes etc. can be subjected to the combined hydrolysis/equilibration process.

In accordance with this preparation procedure, amino-functional alkoxysilanes, water, corresponding siloxanes containing M, D, T and Q units and basic equilibration catalysts initially can be mixed with one another in appropriate ratios and amounts. Heating to 60° C. to 230° C. can then be carried out, with constant thorough mixing. The alcohols split off from the alkoxysilanes and subsequently water can be removed stepwise. The removal of these volatile components and the substantial condensation of undesirable reactive groups can be promoted by using a reaction procedure at elevated temperatures and/or by applying a vacuum.

In order to achieve enhanced removal of the reactive groups, in particular the hydroxyl and alkoxy groups on the silicon atoms, which is as substantial as possible, it has been found that this is rendered possible by a further process step which comprises the removal of the vaporizable condensation products, such as, in particular, water and alcohols, from the reaction mixture by means of an entraining agent. Entraining agents which can be employed to prepare functionalized polysiloxanes to be used according to this invention are: carrier gases, such as nitrogen, low-boiling solvents or oligomeric silanes or siloxanes. The removal of the vaporizable condensation products is preferably carried out by azeotropic distillation out of the equilibrium. Suitable entraining agents for these azeotropic distillations include, for example, entraining agents with a boiling range from about 40 to 200° C. under (normal pressure (1 bar)). Higher alcohols, such as butanol, pentanol and hexanol, halogenated hydrocarbons, such as, for example, methylene chloride and chloroform, aromatics, such as benzene, toluene and xylene, or siloxanes, such as hexamethyldisiloxane and octamethylcyclotetrasiloxane, are preferred. The preparation of the desired preferred aminosiloxanes can be monitored by suitable methods, such as NMR spectroscopy or FTIR spectroscopy, and is concluded when a content of reactive groups which lies within the preferred scope according to the invention is determined.

In one embodiment of this hydrolysis/equilibration process, the desired aminoalkylalkoxysilanes can be prepared in a prior reaction from halogenoalkyl-, epoxyalkyl- and isocyanatoalkyl-functionalized alkoxysilanes. This procedure can be employed successfully if the preferred aminoalkylalkoxysilanes required are not commercially available. Examples of suitable halogenoalkylalkoxysilanes are chloromethylmethyldimethoxysilane and chloropropylmethyldimethoxysilane, an example of epoxyalkylalkoxysilanes is glycidylpropylmethyldmethoxysilane and examples of isocyanate-functionalized silanes are isocyanatopropylmethyldiethoxysilane and isocyanatopropyltriethoxysilane. It is also possible to carry out the functionalization to amino-functional compounds at the stage of the silanes or the equilibrated siloxanes.

Ammonia or structures containing primary, secondary and tertiary amino groups can be used in the preparation of the preferred amino-functionalized silanes and siloxanes. Diprimary amines are of particular interest, and here in particular diprimary alkylamines, such as 1,6-diaminohexane and 1,12-diaminododecane, and diprimary amines based on polyethylene oxide-polypropylene oxide copolymers, such as Jeffamine® of the D and ED series (Huntsman Corp.) can be used. Primary-secondary diamines, such as aminoethylethanolamine, are furthermore preferred. Primary-tertiary diamines, such as N,N-dimethylpropylenediamine, are also preferred. Secondary-tertiary diamines, such as N-methylpiperazine and bis-(N,N-dimethylpropyl)amine, represent a further group of preferred amines. Tertiaryamines, such as trimethylamine, N-methylmorpholine and N,N-dimethylethanolamine, are also preferred. Aromatic amines, such as imidazole, N-methylimidazole, aminopropylimidazole, aniline and N-methylaniline, can also advantageously be employed. After the synthesis has been carried out, these aminoalkylalkoxysilanes are used in the combined hydrolysis/equilibration process hereinbefore described.

Alternatively to the combined hydrolysis/equilibration process, a two-stage process procedure may also be followed. A siloxane precursor high in amino groups is prepared in a separate first step. It is desirable that this siloxane precursor is substantially free from reactive groups, for example silanol and alkoxysilane groups. The synthesis of this siloxane precursor high in amino groups is carried out using the hydrolysis/condensation/equilibration concept already described. A relatively large amount of the amino-functional alkoxysilane, water and relatively small amounts of siloxanes containing M, D, T and Q units as well as basic equilibration catalysts are first mixed with one another in appropriate ratios and amounts. Heating to 60° C. to 230° C. is then carried out with constant thorough mixing, and the alcohols split off from the alkoxysilanes and subsequently water are removed stepwise as hereinbefore described. The composition of this siloxane precursor high in amino groups, including the content of reactive groups, can be determined by suitable methods, such as titration, NMR spectroscopy or FTIR spectroscopy.

In a second, separate equilibration step, the actual preferred target product can be prepared from this siloxane precursor high in amino groups and siloxanes containing M, D, T and Q units under base or acid catalysis. According to requirements for minimization of the end contents of reactive groups, this can again be carried out, as already described, at elevated temperature and/or with vacuum and with azeotropic distillation. The essential advantage of this two-stage method is that the final equilibration proceeds with substantial exclusion of e.g. water and alcohols and the contents of reactive groups in the starting substances are small and known. It is possible to carry out the aminoalkylalkoxysilane synthesis described above in series with the two-stage synthesis.

In addition to having the preferred relatively low content of reactive/curable groups, the functionalized silicones used herein preferably also have a % amine/ammonium functionality, i.e., nitrogen content or % N by weight, in the range of from 0.001% to 0.50%, more preferably from 0.05% to 0.30%. Most preferably, nitrogen content will range from 0.10% to 0.25% by weight. Nitrogen content can be determined by conventional analytical techniques such as by direct elemental analysis or by NMR.

In addition to having the specified curable/reactive group and nitrogen content characteristics, the preferred functionalized silicone materials used herein will also have certain viscosity characteristics. In particular, the functionalized polysiloxane materials used herein preferably have a viscosity from 0.00002 m²/s (20 centistokes at 20° C.) to 0.2 m²/s (200,000 centistokes at 20° C.), more preferably from 0.001 m²/s (1000 centistokes at 20° C.) to 0.1 m²/s (100,000 centistokes at 20° C.), and most preferably from 0.002 m²/s (2000 centistokes at 20° C.) to 0.01 m²/s (10,000 centistokes at 20° C.).

The preferred functionalized silicones will also have a molecular weight in the range of from 2,000 Da to 100,000 Da, preferably from 15,000 Da to 50,000 Da, most preferably from 20,000 Da to 40,000 Da, most preferably from 25,000 Da to 35,000 Da.

Examples of preferred functionalized silicones for use in the compositions of the present invention include but are not limited to, those which conform to the general formula (A):
(R¹)ₐG₃₋ₐ—Si—(—OSiG₂)ₙ—(—OSiG_{b}(R¹)_{2-b})ₘ—O—SiG₃₋ₐ(R¹)ₐ (A)
wherein G is phenyl, or C₁-C₈ alkyl, preferably methyl; a is 0 or an integer having a value from 1 to 3, preferably 0; b is 0, 1 or 2, preferably 1; n is a number from 49 to 1299, preferably from 100 to 1000, more preferably from 150 to 600; m is an integer from 1 to 50, preferably from 1 to 5; most preferably from 1 to 3 the sum of n and m is a number from 50 to 1300, preferably from 150 to 600; R¹ is a monovalent radical conforming to the general formula C_{q}H_{2q}L, wherein q is an integer having a value from 2 to 8 and L is selected from the following groups: —N(R²)CH₂—CH₂—N(R²)₂; —N(R²)₂; wherein R² is hydrogen, phenyl, benzyl, hydroxyalkyl or a saturated hydrocarbon radical, preferably an alkyl radical of from C₁ to C₂₀.

A preferred aminosilicone corresponding to formula (A) is the shown below in formula (B): 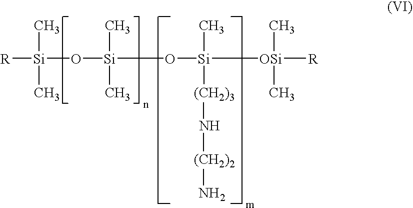
wherein R is independently selected from C₁ to C₄ alkyl, hydroxyalkyl and combinations thereof, preferably from methyl and wherein n and m are hereinbefore defined. When both R groups are methyl, the above polymer is known as “trimethylsilylamodimethicone”.

b1) Non-Functionalized Silicones:

For purposes of this invention, a non-functionalized (or non-polarly functionalized) silicone is a polymer containing repeating SiO groups and substitutents which comprise of carbon, hydrogen and oxygen (or one or more non-polar substituents). Thus, the non-functionalized or non-polarly functionalized silicones selected for use in the compositions of the present invention include any nonionic, non-cross linked, nitrogen-free, non-cyclic silicone polymer.

Preferably, the non-functionalized silicone is selected from nonionic nitrogen-free silicone polymers having the Formula (I): 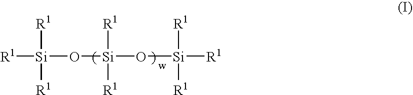
wherein each R¹ is independently selected from the group consisting of linear, branched or cyclic alkyl groups having from 1 to 20 carbon atoms; linear, branched or cyclic alkenyl groups having from 2 to 20 carbon atoms; aryl groups having from 6 to 20 carbon atoms; alkylaryl groups having from 7 to 20 carbon atoms; arylalkyl and arylalkenyl groups having from 7 to 20 carbon atoms and combinations thereof. selected from the group consisting of linear, branched or cyclic alkyl groups having from 1 to 20 carbon atoms; linear, branched or cyclic alkenyl groups having from 2 to 20 carbon atoms; aryl groups having from 6 to 20 carbon atoms; alkylaryl groups having from 7 to 20 carbon atoms; arylalkyl; arylalkenyl groups having from 7 to 20 carbon atoms and wherein the index w has a value such that the viscosity of the nitrogen-free silicone polymer is between 0.01 m²/s (10,000 centistokes at 20° C.) to 2.0 m²/s (2,000,000 centistokes at 20° C.), more preferably from 0.05 m²/s (50,000 centistokes at 20° C.) to 1.0 m²/s (1,000,000 centistokes at 20° C.).

More preferably, the non-functionalized silicone is selected from linear nonionic silicones having the Formulae (I), wherein R¹ is selected from the group consisting of methyl, phenyl, and phenylalkyl, most preferably methyl.

Non-limiting examples of nitrogen-free silicone polymers of Formula (I) include the Silicone 200 fluid series from Dow Corning and Baysilone Fluids M 600,000 and 100,000 from Bayer AG.

b3) Silicone Blend

The blend of polarly-functionalized and non-functionalized or non-polarly functionalized silicones can be formed by simply admixing these two types of silicones together in the appropriate desired ratios. Silicone materials of these two essential types must be miscible liquids when their compositions are as specified herein. The silicone blend then can then be added as is to the detergent compositions herein under agitation to form droplets of the miscible silicone blend within the detergent composition.

Generally the weight ratio of polarly-functionalized polysiloxane material to non-functionalized or non-polarly functionalized polysiloxane material in the silicone blend will range from 100:1 to 1:100. More preferably the blend will contain polarly-functionalized and non-functionalized/non-polarly functionalized silicones in a weight ratio of from 1:25 to 5:1, even more preferably from 1:20 to 1:1, and most preferably from 1:15 to 1:2.

The blends of polarly-functionalized and non-functionalized/non-polarly functionalized polysiloxanes used in the detergent compositions herein are preferably also “miscible.” For purposes of this invention, such silicone blends are “miscible” if they mix freely and exhibit no phase separation at 20° C. when these two types of silicones are admixed within the broad weight ratio range of from 100:1 to 1:100.

Without being limited by theory, the polar functionality, e.g., nitrogen, content of the polarly-functionalized polysiloxane is fundamentally linked to the ability to obtain miscibility of the polarly-functionalized and non-functionalized/non-polarly functionalized silicones, and the blend combination of the two acts synergistically. Moreover, while the levels of reactive group content of the polarly-functionalized silicones are preferably low, they do not need to be zero. This is believed to be due, at least in part, to the ability of the non-functionalized or non-polarly-functionalized silicone to protect the polarly-functionalized silicone from interaction with perfumery components of the aqueous liquid detergent composition. Therefore in broad general terms, to arrive at the benefits of the invention, one needs to have a miscible blend of a polarly-functionalized silicone and a non-functional or non-polarly functionalized silicone, more preferably a miscible blend of an aminosilicone that has the specified structure and compositional limits set forth herein and a non-functionalized polydimethylsiloxane (PDMS). By use of the invention, it becomes un-necessary to resort to expensive encapsulation of perfume, and the fabric care benefits provided remain excellent. Thus another aspect of the solution provided by the present invention is that use of the nonfunctional or non-polarly functionalized silicone permits a greater tolerance for reactive groups in the polarly-functionalized silicone than would otherwise be tolerable in terms of perfume compatibility.

The miscible silicone blend present as droplets in the liquid detergent can get into the liquid detergent composition formulation in a number of different ways provided that the two essential silicones are mixed before adding them to the balance of the liquid detergent composition. They can be mixed “neat” to form the blend, or, more preferably, the silicone blends can be introduced into the liquid detergent being added as “silicone emulsions”. “Silicone emulsions” herein, unless otherwise made clear, refers to combinations of the blended essential silicones with water plus other adjuncts such as emulsifiers, biocides, thickeners, solvents and the like. The silicone emulsions can be stable, in which case they are useful articles of commerce, practically convenient to handle in the detergent plant, and can be transported conveniently. The silicone emulsions can also be unstable. For example, a temporary silicone emulsion of the blended silicones can be made from the neat silicones in a detergent plant, and this temporary silicone emulsion can then be mixed with the balance of the liquid detergent provided that a dispersion of the droplets having the preferred particle sizes specified herein is the substantially uniform result. (When referring to percentages of ingredients in the liquid detergents, the convention will be used herein of accounting only the essential silicones in the “silicone blend” part of the composition, with all minor ingredients e.g., emulsifiers, biocides, solvents and the like, being accounted for in conjunction with recital of the non-silicone component levels of the formulation.)

In a preferred embodiment of the present invention, the silicone blend is emulsified with water and an emulsifier to form an emulsion which can be used as a separate component of the detergent composition. Such a preformed oil-in-water emulsion can then be added to the other ingredients to form the final liquid laundry detergent composition of the present invention.

The weight ratio of the silicone blend to the emulsifier is generally between 500:1 and 1:50, more preferably between 200:1 and 1:1, and most preferably greater than 2:1. The concentration of the silicone blend in the oil-in-water emulsion will generally range from 5% to 60% by weight of the emulsion, more preferably from 35% to 50% by weight of the emulsion. Preferred silicone blend emulsions for convenient transportation from a silicone manufacturing facility to a liquid detergent manufacturing facility will typically contain these amounts of silicone, with the balance of suitable transportation blends being water, emulsifiers and minor components such as bacteriostats. In such compositions the weight ratio of the silicone blend to water will generally lie in the range from 1:50 to 10:1, more preferably from 1:10 to 1:1.

Any emulsifier which is chemically and physically compatible with all other ingredients of the compositions of the present invention is suitable for use therein and in general the emulsifier can have widely ranging HLB, for example an HLB from 1 to 100. Typically the HLB of the emulsifier will lie in the range from 2 to 20. Cationic emulsifiers, nonionic emulsifiers and mixtures thereof are useful herein. Emulsifiers may also be silicone emulsifiers or non-silicone emulsifiers. Useful emulsifiers also include two- and three-component emulsifier mixtures. The invention includes embodiments wherein two emulsifiers or three emulsifiers are added in forming the silicone blends.

Nonionic emulsifiers:

One type of nonionic emulsifier suitable for use herein comprises the “common” polyether alkyl nonionics. These include alcohol ethoxylates such as Neodol 23-5 ex Shell and Slovasol 458 ex Sasol. Other suitable nonionic emulsifiers include alkyl poly glucoside-based emulsifiers such as those disclosed in U.S. Pat. No. 4,565,647, Llenado, issued Jan. 21, 1986, having a hydrophobic group containing from 6 to 30 carbon atoms, preferably from 8 to 16 carbon atoms, more preferably from 10 to 12 carbon atoms, and a polysaccharide, e.g. a polyglycoside, hydrophilic group containing from 1.3 to 10, preferably from 1.3 to 3, most preferably from 1.3 to 2.7 saccharide units. Any reducing saccharide containing 5 or 6 carbon atoms can be used, e.g., glucose, galactose and galactosyl moieties can be substituted for the glucosyl moieties (optionally the hydrophobic group is attached at the 2-, 3-, 4-, etc. positions thus giving a glucose or galactose as opposed to a glucoside or galactoside). The intersaccharide bonds can be, e.g., between the one position of the additional saccharide units and the 2-, 3-, 4-, and/or 6-positions on the preceding saccharide units.

Preferred alkylpolyglycosides have the formula
R²O(CₙH₂ₙO)ₜ(glycosyl)ₓ
wherein R² is selected from the group consisting of alkyl, alkylphenyl, hydroxyalkyl, hydroxyalkylphenyl, and combinations thereof in which the alkyl groups contain from 6 to 30, preferably from 8 to 16, more preferably from 10 to 12 carbon atoms; n is 2 or 3, preferably 2; t is from 0 to 10, preferably 0; and x is from 1.3 to 10, preferably from 1.3 to 3, most preferably from 1.3 to 2.7. The glycosyl is preferably derived from glucose. To prepare these compounds, the alcohol or alkylpolyethoxy alcohol is formed first and then reacted with glucose, or a source of glucose, to form the glucoside (attachment at the 1-position). The additional glycosyl units can then be attached between their 1-position and the preceding glycosyl units 2-, 3-, 4- and/or 6-position, preferably predominately the 2-position. Compounds of this type and their use in detergents are disclosed in EP-B 0 070 077, 0 075 996, 0 094 118, and in WO 98/00498.

Still other types of useful nonionic emulsifiers for making silicone blend emulsions include other polyol surfactants such as sorbitan esters (e.g. Span 80 ex Uniqema, Crill 4 ex Croda) and ethoxylated sorbitan esters. Polyoxyethylene fatty acid esters (e.g. Myrj 59 ex Uniqema) and ethoxylated glycerol esters may also be used as can fatty amides/amines and ethoxylated fatty amides/amines.

Cationic Emulsifiers:

Cationic emulsifiers suitable for use in the silicone blends of the present invention have at least one quaternized nitrogen and one long-chain hydrocarbyl group. Compounds comprising two, three or even four long-chain hydrocarbyl groups are also included. Examples of such cationic emulsifiers include alkyltrimethylammonium salts or their hydroxyalkyl substituted analogs, preferably compounds having the formula R¹R²R³R⁴N⁺X⁻. R¹, R², R³ and R⁴ are independently selected from C₁-C₂₆ alkyl, alkenyl, hydroxyalkyl, benzyl, alkylbenzyl, alkenylbenzyl, benzylalkyl, benzylalkenyl and X is an anion. The hydrocarbyl groups R¹, R², R³ and R⁴ can independently be alkoxylated, preferably ethoxylated or propoxylated, more preferably ethoxylated with groups of the general formula (C₂H₄O)ₓH where x has a value from 1 to 15, preferably from 2 to 5. Not more than one of R², R³ or R⁴ should be benzyl. The hydrocarbyl groups R¹, R², R³ and R⁴ can independently comprise one or more, preferably two, ester-([—O—C(O)—]; [—C(O)—O—]) and/or an amido-groups ([O—N(R)—]; [—N(R)—O—]) wherein R is defined as R¹ above. The anion X may be selected from halide, methysulfate, acetate and phosphate, preferably from halide and methylsulfate, more preferably from chloride and bromide. The R¹, R², R³ and R⁴ hydrocarbyl chains can be fully saturated or unsaturated with varying Iodine value, preferably with an Iodine value of from 0 to 140. At least 50% of each long chain alkyl or alkenyl group is predominantly linear, but also branched and/or cyclic groups are included.

For cationic emulsifiers comprising only one long hydrocarbyl chain, the preferred alkyl chain length for R¹ is C₁₂-C₁₅ and preferred groups for R², R³ and R⁴ are methyl and hydroxyethyl.

For cationic emulsifiers comprising two or three or even four long hydrocarbyl chains, the preferred overall chain length is C₁₈, though combinations of chain lengths having non-zero proportions of lower, e.g., C₁₂, C₁₄, C₁₆ and some higher, e.g., C₂₀ chains can be quite desirable.

Preferred ester-containing emulsifiers have the general formula
{(R₅)₂N((CH₂)ₙER₆)₂}⁺X⁻
wherein each R₅ group is independently selected from C₁₋₄ alkyl, hydroxyalkyl or C₂₋₄ alkenyl; and wherein each R₆ is independently selected from C₈₋₂₈ alkyl or alkenyl groups; E is an ester moiety i.e., —OC(O)— or —C(O)O—, n is an integer from 0 to 5, and X⁻ is a suitable anion, for example chloride, methosulfate and combinations thereof.

A second type of preferred ester-containing cationic emulsifiers can be represented by the formula: {(R₅)₃N(CH₂)ₙCH(O(O)CR₆)CH₂O(O)CR₆}⁺X⁻ wherein R₅, R₆, X and n are defined as above. This latter class can be exemplified by 1,2 bis[hardened tallowoyloxy]-3-trimethylammonium propane chloride.

The cationic emulsifiers, suitable for use in the blends of the present invention can be either water-soluble, water-dispersible or water-insoluble.

Silicone Emulsifiers:

Silicone emulsifiers useful herein are nonionic, do not include any nitrogen, and do not include any of the non-functionalized silicones described hereinbefore. Silicone emulsifiers are described for example in “Silicone Surfactants” in the Surfactant Science Series, Volume 86 (Editor Randal M. Hill), Marcel Dekker, NY, 1999. See especially Chapter 2, “Silicone Polyether Copolymers: Synthetic Methods and Chemical Compositions and Chapter 1, “Siloxane Surfactants”.

Especially suitable silicone emulsifiers are polyalkoxylated silicones corresponding to those of the structural Formula I set forth hereinbefore wherein R¹ is selected from the definitions set forth hereinbefore and from poly(ethyleneoxide/propyleneoxide) copolymer groups having the general formula (II):
—(CH₂)ₙO(C₂H₄O)_{c}(C₃H₆O)_{d}R³ (II)
with at least one R¹ being such a poly(ethyleneoxy/propyleneoxy) copolymer group, and each R³ is independently selected from the group consisting of hydrogen, an alkyl having 1 to 4 carbon atoms, and an acetyl group; and wherein the index w has a value such that the viscosity of the resulting silicone emulsifier ranges from 0.00002 m²/sec to 0.2 m²/sec.
Emulsifier Diluents:

The emulsifier may also optionally be diluted with a solvent or solvent system before emulsification of the silicone blend. Typically, the diluted emulsifier is added to the pre-formed silicone blend. Suitable solvents can be aqueous or non-aqueous; and can include water alone or organic solvents alone and/or combinations thereof. Preferred organic solvents include monohydric alcohols, dihydric alcohols, polyhydric alcohols, ethers, alkoxylated ethers, low-viscosity silicone-containing solvents such as cyclic dimethyl siloxanes and combinations thereof. Preferred are glycerol, glycols, polyalkylene glycols such as polyethylene glycols, dialkylene glycol mono C₁-C₈ ethers and combinations thereof. Even more preferred are diethylene glycol, diethylene glycol mono ethyl ether, diethylene glycol mono propyl ether, diethylene glycol mono butyl ether, and combinations thereof. Highly preferred are combinations of solvents, especially combinations of lower aliphatic alcohols such as ethanol, propanol, butanol, isopropanol, and/or diols such as 1,2-propanediol or 1,3-propanediol; or combinations thereof with dialkylene glycols, dialkylene glycol mono C₁-C₈ ethers and/or glycols and/or water. Suitable monohydric alcohols especially include C₁-C₄ alcohols.

b4) Silicone Blend in Detergent Composition

The silicone blend as hereinbefore described will generally comprise from 0.05% to 10% by weight of the liquid detergent composition. More preferably, the silicone blend will comprise from 0.1% to 5.0%, even more preferably from 0.25% to 3.0%, and most preferably from 0.5% to 2.0%, by weight of the liquid detergent composition. The silicone blend will generally be added to some or all of the other liquid detergent composition components under agitation to disperse the blend therein.

Within the liquid detergent compositions herein, the silicone blend, either having added emulsifiers present or absent, will be present in the form of droplets. Within the detergent composition, and within emulsions formed from the silicone blend, such droplets will generally have a median silicone particle size of from 0.5 μm to 300 μm, preferably no greater than 200 microns, more preferably from 0.5 μm to 100 μm and even more preferably from 0.6 μm to 50 μm. As indicated, particle size may be measured by means of a laser scattering technique, using a Coulter LS 230 Laser Diffraction Particle Size Analyser from Coulter Corporation, Miami, Fla., 33196, USA). Particle sizes are measured in volume weighted % mode, calculating the median particle size. Another method which can be used for measuring the particle size is by means of a microscope, using a microscope manufactured by Nikon® Corporation, Tokyo, Japan; type Nikon® E-1000 (enlargement 700×).

C) Aldehyde and/or Ketone-Based Perfume Ingredients

Another essential component of the liquid detergent compositions herein comprises perfume or fragrance ingredients which comprise fragrant aldehydes or ketones or compounds which produce such aldehyde or ketone compounds in situ. Aldehydes and ketones are well known components of perfume compositions. They can be present in combination with other types of perfume materials as part of multi-component perfume formulations. Perfume ingredients in the form or aldehydes or ketones, in the absence of the special measures employed in the context of the present invention, can react with polarly-functionalized silicone fabric care agent, thereby potentially deactivating both types of materials.

Suitable aldehyde perfume ingredients include hexyl aldehyde, heptyl aldehyde, octyl aldehdyde, nonyl aldehyde, 3,5,5-trimethyl hexanal, decyl aldehyde, undecyl aldehyde, dodecyl aldehyde, nonenal, decenal (decenal-4-trans), undecenal (aldehyde iso C11, 10-Undecenal), nonadienal, 2,6,10-trimethyl-9-undecenal, 2-methylundecanal, geranial, neral, citronellal, dihydrocitronellal, 2,4-dimethyl-3-cyclohexene-1-carboxaldehyde, 2-methyl-3-(4-isopropylphenyl)propanal, 2-methyl-3-(4-tert.-butylphenyl)propanal, 2-methyl-3-(4-(2-methylpropyl)phenyl)propanal, anisic aldehyde, cetonal, 3-(3-isopropylphenyl)butanal, 2,6-dimethyl-heptenal, 4-methyphenylacetaldehyde, 1-methyl-4(4-methylpentyl)-3-cyclohexene-carbaldehyde, butyl cinnamic aldehyde, amyl cinnamic aldehyde, hexyl cinnamic aldehyde, 4-methyl-alpha-pentyl cinnamic aldehyde, alpha-2,2,3-tetramethyl-3-cyclopentene-1-butyraldehyde (santafleur), isohexenyl tetrahydro benzaldehyde, citronellyl oxyacetaldehyde, melafleur, lyral, 2-methyl-3 (para-methoxy phenyl)-propanal, cyclemone A, para-ethyl-alpha,alpha-dimethyl hydrocinnamaldehyde, dimethyl decadienal, alpah-methyl-3,4-(methylenedoxy) hydrocinnamaldehyde, isocyclocitral, methyl cinnamic aldehyde, and methyl octyl aldehyde. Suitable ketone perfume ingredients include alpha-damascone, beta-damascone, deltadamascone, damascenone, dihydro ionone beta, geranyl acetone, benzyl acetone, beta ionone, alpha ionone, gamma methyl ionone, methyl heptenone, 2-(2-(4-methyl-3-cyclohexen-1-yl)propyl)cyclopentanone, 5-cyclohexadecen-1-one, 6,7 dihydro-1,1,2,3,3,-pentamethyl-4(5H)-indanone, heptyl cyclopentanone, hexyl cyclopentanone, 7-acetyl, 1,2,3,4,5,6,7,8-octahydro-1,1,6,7-tetramethyl naphthalene, isocyclemone E, methyl cedryl ketone, and methyl dihydrojasmonate.

The perfume component of the compositions herein may also comprise a material such as a pro-perfume which can yield, for example by hydrolyzing, a fragrant aldehyde or ketone in situ. Pro-perfume materials of this type include compounds in the form of acetals, ketals, beta-keto-esters, oxazolidines, and the like. Such materials are described in greater detail in WO 97/34986; WO98/07813; WO 99/16740 and WO 00/24721. Suitable pro-perfumes which can yield fragrant aldehydes and/or ketones also include the Schiff-base materials which are the reaction products of such perfume aldehydes and/or ketones with primary or secondary amines such as polyethyleneimines. Materials of this type are described in greater detail in WO 00/02987 and WO 00/02991.

The aldehyde and/or ketone perfume or pro-perfume materials will generally be present in the liquid detergent compositions herein in amounts which are effective to provide the desired degree and intensity of fragrance characteristics to such compositions. Typically the total amount of aldehyde- and ketone-based perfume components in the compositions herein will range from 0.00001% to 0.1% by weight, more preferably from 0.001% to 0.05% by weight of the compositions herein. As indicated, such aldehyde- and ketone-based perfumes can be present in these amounts as part of an overall perfume component which may contain other chemical types of perfume ingredients as well.

D) Aqueous Base

The liquid detergent compositions of the present invention must contain water since taehyare aqueous in nature. Accordingly, the detergent compositions herein will contain at least 4% by weight of water. More preferably such compositions will contain at least 20% by weight of water, even more preferably at least 50% by weight of water.

Optional Preferred Detergent Composition Ingredients

In addition to the essential components hereinbefore described, the aqueous liquid laundry detergent compositions of this invention can optionally contain a variety of conventional ingredients to enhance composition performance or stability. Inclusion of certain of these conventional optional components is especially preferred in the context of the silicone-containing products of this invention. These include coacervate phase-forming polymers or cationic deposition aids, ancillary quaternary ammonium softening compounds, structurants or thickening agents for the liquid compositions herein, detersive enzymes, dye transfer inhibition agents, optical brighteners and suds suppressors/antifoam agents.

E) Coacervate Phase-Forming Polymer or Cationic Deposition Aid

The liquid laundry detergent compositions of the present invention may optionally contain up to 1% by weight, more preferably from 0.01% to 0.5% by weight of a coacervate phase-forming polymer or cationic deposition aid. Alternatively the compositions herein may be essentially free of such a coacervate former or cationic deposition aid. Essentially free means less than 0.01%, preferably less than 0.005%, more preferably less than 0.001% by weight of the composition, and most preferably completely or totally free of any coacervate phase-forming polymer and of any cationic deposition aid. Materials of this type serve to enhance deposition of fabric care agents, such as the silicone-based fabric treatment agents used herein, onto the surfaces of fabrics and textiles being laundered using the laundry detergent compositions of this invention.

For purposes of this invention, a coacervate phase-forming polymer is any polymer material which will react, interact, complex or coacervate with any of the composition components to form a coacervate phase. The phrase “coacervate phase” includes all kinds of separated polymer phases known by the person skilled in the art such as disclosed in L. Piculell & B. Lindman, Adv. Colloid Interface Sci., 41 (1992) and in B. Jonsson, B. Lindman, K. Holmberg, & B. Kronberb, “Surfactants and Polymers In Aqueous Solution”, John Wiley & Sons, 1998. The mechanism of coacervation and all its specific forms are fully described in “Interfacial Forces in Aqueous Media”, C. J. van Oss, Marcel Dekker, 1994, pages 245 to 271. When using the phrase “coacervate phase”, it should be understood that such a term is also occasionally referred to as “complex coacervate phase” or as “associated phase separation” in the literature.

Also for purpose of this invention, a cationic deposition aid is a polymer which has cationic, functional substituents and which serve to enhance or promote the deposition onto fabrics of one or more fabric care agents during laundering operations. Many but not all cationic deposition aids are also coacervate phase-forming polymers.

Typical coacervate phase-forming polymers and any cationic deposition aids are homopolymers or can be formed from two or more types of monomers. The molecular weight of the polymer will generally be between 5,000 and 10,000,000, typically at least 10,000 and more typically in the range 100,000 to 2,000,000. Coacervate phase-forming polymers and cationic deposition aids typically have cationic charge densities of at least 0.2 meq/gm at the pH of intended use of the composition, which pH will generally range from pH 3 to pH 9, more generally between pH 4 and pH 8. The coacervate phase-forming polymers and any cationic deposition aids are typically of natural or synthetic origin and selected from the group consisting of substituted and unsubstituted polyquaternary ammonium compounds, cationically modified polysaccharides, cationically modified (meth)acrylamide polymers/copolymers, cationically modified (meth)acrylate polymers/copolymers, chitosan, quaternized vinylimidazole polymers/copolymers, dimethyldiallylammonium polymers/copolymers, polyethylene imine based polymers, cationic guar gums, and derivatives thereof and combinations thereof.

These polymers may have cationic nitrogen containing groups such as quaternary ammonium or protonated amino groups, or a combination thereof. The cationic nitrogen-containing group are generally be present as a substituent on a fraction of the total monomer units of the cationic polymer. Thus, when the polymer is not a homopolymer it will frequently contain spacing non-cationic monomer units. Such polymers are described in the CTFA Cosmetic Ingredient Directory, 7^{th} edition.

Non-limiting examples of included, excluded or minimized coacervate phase-forming cationic polymers include copolymers of vinyl monomers having cationic protonated amine or quaternary ammonium functionalities with water soluble spacer monomers such as acrylamide, methacrylamide, alkyl and dialkyl acrylamides, alkyl and dialkyl methacrylamides, alkyl acrylate, alkyl methacrylate, vinyl caprolactone and vinyl pyrrolidine. The alkyl and dialkyl substituted monomers typically have C₁-C₇ alkyl groups, more typically C₁-C₃ alkyl groups. Other spacers include vinyl esters, vinyl alcohol, maleic anhydride, propylene glycol and ethylene glycol.

Other included, excluded or minimized coacervate phase-forming cationic polymers include, for example: a) copolymers of 1-vinyl-2-pyrrolidine and 1-vinyl-3-methyl-imidazolium salt (e.g. chloride alt), referred to in the industry by the Cosmetic, Toiletry, and Fragrance Association, (CTFA) as Polyquaternium-16. This material is commercially available from BASF Wyandotte Corp. under the LUVIQUAT tradenname (e.g. LUVIQUAT FC 370); b) copolymers of 1-vinyl-2-pyrrolidine and dimethylaminoethyl methacrylate, referred to in the industry (CTFA) as Polyquaternium-11. This material is available commercially from Graf Corporation (Wayne, N.J., USA) under the GAFQUAT tradename (e.g. GAFQUAT 755N); c) cationic diallyl quaternary ammonium-containing polymers including, for example, dimethyldiallylammonium chloride homopolymer and copolymers of acrylamide and dimethyldiallylammonium chloride, reffered to in the industry (CTFA) as Polyquaternium 6 and Polyquaternium 7, respectively; d) mineral acid salts of amino-alkyl esters of homo- and copolymers of unsaturated carboxylic acids having from 3 to 5 carbon atoms as describes in U.S. Pat. No. 4,009,256; e) amphoteric copolymers of acrylic acid including copolymers of acrylic acid and dimethyldiallylammonium chloride (referred to in the industry by CTFA as Polyquaternium 22), terpolymers of acrylic acid with dimethyldiallylammonium chloride and acrylamide (referred to in the industry by CTFA as Polyquaternium 39), and terpolymers of acrylic acid with methacrylamidopropyl trimethylammonium chloride and methylacrylate (referred to in the industry by CTFA as Polyquaternium 47).

Other included, excluded or minimized coacervate phase-forming polymers and any cationic deposition aids include cationic polysaccharide polymers, such as cationic cellulose and derivatives thereof, cationic starch and derivatives thereof, and cationic guar gums and derivatives thereof.

Cationic polysaccharide polymers include those of the formula:
A-O—[R—N⁺(R¹)(R²)(R³)]X⁻
wherein A is an anhydroglucose residual group, such as a starch or cellulose anhydroglucose residual, R is an alkylene, oxyalkylene, polyoxyalkylene, or hydroxyalkylene group, or combination thereof; and R¹, R², and R³ independently represent alkyl, aryl, alkylaryl, arylalkyl, alkoxyalkyl, or alkoxyaryl, each group comprising up to 18 carbon atoms. The total number of carbon atoms for each cationic moiety (i.e. the sum of carbon atoms in R¹, R², and R³) is typically 20 or less, and X is an anionic counterion as described hereinbefore.

A particular type of commercially utilized cationic polysaccharide polymer is a cationic guar gum derivative, such as the cationic polygalactomannan gum derivatives described in U.S. Pat. No. 4,298,494, which are commercially available from Rhone-Poulenc in their JAGUAR tradename series. An example of a suitable material is hydroxypropyltrimonium chloride of the formula: 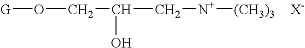
where G represents guar gum, and X is an anionic counterion as described hereinbefore, typically chloride. Such a material is available under the tradename of JAGUAR C-13-S. In JAGUAR C-13-S the cationic charge density is 0.7 meq/gm. Similar cationic guar gums are also available from AQUALON under the tradename of N-Hance® 3196 and Galactosol® SP813S.

Still other types of cationic celloulosic deposition aids are those of the general structural formula: 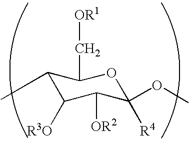
wherein R¹, R², R³ are each independently H, CH₃, C₈₋₂₄ alkyl (linear or branched), 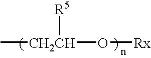
or mixtures thereof; wherein n is from about 1 to about 10; Rx is H, CH₃, C₈₋₂₄ alkyl (linear or branched), 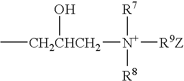
or mixtures thereof, wherein Z is a chlorine ion, bromine ion, or mixture thereof; R⁵ is H, CH₃, CH₂CH₃, or mixtures thereof; R⁷ is CH₃, CH₂CH₃, a phenyl group, a C₈₋₂₄ alkyl group (linear or branched), or mixture thereof; and
R⁸ and R⁹ are each independently CH₃, CH₂CH₃, phenyl, or mixtures thereof:
R⁴ is H 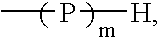
   or mixtures thereof wherein P is a repeat unit of an addition polymer formed by radical polymerization of a cationic monomer 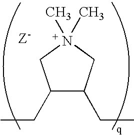
   wherein Z′ is a chlorine ion, bromine ion or mixtures thereof and q is from about 1 to about 10.

Cationic cellulosic deposition aids of this type are described more fully in WO 04/022686. Reference is also made to “Principles of Polymer Science and Technology in Cosmetics and Personal Care” by Goddard and Gruber and in particular to pages 260-261, where an additional list of synthetic cationic polymers to be included, excluded or minimized can be found.

F) Quaternary Ammonium Fabric-Softening Agent

The compositions herein also optionally contain from about 1% to about 10%, preferably from about 1% to about 4%, more preferably from about 1.5% to about 3%, by weight of a quaternary ammonium fabric-softening agent of the formula: 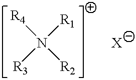
wherein R₁ and R₂ are individually selected from the group consisting of C₁-C₄ alkyl, C₁-C₄ hydroxy alkyl, benzyl, and —(C₂H₄O)ₓH where x has a value from about 2 to about 5; X is an anion; and (1) R₃ and R₄ are each a C₈-C₁₄ alkyl or (2) R₃ is a C₈-C₂₂ alkyl and R₄ is selected from the group consisting of C₁-C₁₀ alkyl, C₁-C₁₀ hydroxy alkyl, benzyl, and —(C₂H₄O)ₓH where x has a value from about 2 to about 5. Preferred of the above are the mono-long chain alkyl quaternary ammonium surfactants wherein the above formula R₁, R₂, and R₃ are each methyl and R₄ is a C₈-C₁₈ alkyl.

The most preferred quaternary ammonium surfactants are the chloride, bromide and methylsulfate C₈₋₁₆ alkyl trimethyl ammonium salts, and C₈₋₁₆ alkyl di(hydroxyethyl)-methyl ammonium salts. Of the above, lauryl trimethyl ammonium chloride, myristyl trimethyl ammonium chloride and coconut trimethylammonium chloride and methylsulfate are particularly preferred. ADOGEN 412™, a lauryl trimethyl ammonium chloride commercially available from Witco, is a preferred softening agent herein.

Another class of preferred quaternary ammonium surfactants is the di-C₈-C₁₄ alkyl dimethyl ammonium chloride or methylsulfates; particularly preferred is di-C₁₂-C₁₄ alkyl dimethyl ammonium chloride. This class of materials is particularly suited to providing antistatic benefits to fabrics. Materials having two alkyl chain lengths longer than C₁₄, like di-C₁₆-C₁₈ alkyl dimethyl ammonium chloride, which are commonly used in rinse added fabric softeners, are preferably not included in the compositions of this invention, since they do not yield isotropic liquid detergents when combined with the anionic surfactants described above.

In connection with the inclusion of quaternary ammonium softening agents, it may be desirable for the compositions herein to also contain from about 0.01% to about 10%, preferably from about 2% to about 7%, more preferably from about 3% to about 5%, by weight the composition, of one or more fatty acids containing from about 8 to about 20 carbon atoms. The fatty acid can also contain from about 1 to about 10 ethylene oxide units in the hydrocarbon chain. Fatty acids of this type may form ion pairs with the quaternary ammonium materials, and these ion pair can provide through the wash fabric softening benefits.

Suitable fatty acids are saturated and/or unsaturated and can be obtained from natural sources such a plant or animal esters (e.g., palm kernel oil, palm oil, coconut oil, babassu oil, safflower oil, tall oil, castor oil, tallow and fish oils, grease, and mixtures thereof), or synthetically prepared (e.g., via the oxidation of petroleum or by hydrogenation of carbon monoxide via the Fisher Tropsch process). Examples of suitable saturated fatty acids for use in the compositions of this invention include captic, lauric, myristic, palmitic, stearic, arachidic and behenic acid. Suitable unsaturated fatty acid species include: palmitoleic, oleic, linoleic, linolenic and ricinoleic acid. Examples of preferred fatty acids are saturated C₁₂ fatty acid, saturated C₁₂-C₁₄ fatty acids, and saturated or unsaturated C₁₂ to C₁₈ fatty acids, and mixtures thereof.

In the detergent compositions herein containing both a quaternary ammonium softening agent and a fatty acid component, the weight ratio of quaternary ammonium softening agent to fatty acid is preferably from about 1:3 to about 3:1, more preferably from about 1:1.5 to about 1.5:1, most preferably about 1:1. Use of combinations of quaternary ammonium fabric softeners and fatty acids in the context of liquid detergent compositions is described in greater detail in U.S. Pat. Nos. 5,468,413; 5,466,394; and 5,622,925.

Combinations of the miscible blend of silicones and an ancillary quaternary ammonium softener (with or without fatty acid) can provide especially desirable fabric care performance via the laundry detergent compositions of this invention. Use of this combination of materials can allow both types of fabric care agents to co-deposit onto fabrics through the wash and permits the uses of smaller amounts of each than would normally be employed if such fabric care agents were not co-utilized.

G) Structurants

The compositions herein can optionally contain a variety of materials suitable as external structurants or thickeners for the aqueous liquid phase of the compositions herein. One preferred type of optional structuring agent which is especially useful in the compositions of the present invention comprises non-polymeric (except for conventional alkoxylation), crystalline hydroxy-functional materials which can form thread-like structuring systems throughout the liquid matrix of the detergent compositions herein when they are crystallized within the matrix in situ. Such materials can be generally characterized as crystalline, hydroxyl-containing fatty acids, fatty esters or fatty waxes.

Specific examples of preferred crystalline, hydroxyl-containing structurants include castor oil and its derivatives. Especially preferred are hydrogenated castor oil derivatives such as hydrogenated castor oil and hydrogenated castor wax. Commercially available, castor oil-based, crystalline, hydroxyl-containing structurants include THIXCIN® from Rheox, Inc. (now Elementis).

All of these crystalline, hydroxyl-containing structurants as hereinbefore described are believed to function by forming thread-like structuring systems when they are crystallized in situ within the aqueous liquid matrix of the compositions herein or within a pre-mix which is used to form such an aqueous liquid matrix. Such crystallization is brought about by heating an aqueous mixture of these materials to a temperature above the melting point of the structurant, followed by cooling of the mixture to room temperature while maintaining the liquid under agitation. higher concentrations to minimize undesirable phase separation. These preferred crystalline, hydroxyl-containing structurants, and their incorporation into aqueous liquid matrices, are described in greater detail in U.S. Pat. No. 6,080,708 and in PCT Publication No. WO 02/40627.

Other suitable types of materials useful as optional structurants for the compositions herein comprises those polymeric structurant selected from the group consisting of polyacrylates and derivatives thereof; polysaccharides and derivatives thereof; polymer gums and combinations thereof. Polyacrylate-type structurants comprise in particular polyacrylate polymers and copolymers of acrylate and methacrylate. An example of a suitable polyacrylate type structurant is Carbopol Aqua 30 available from B.F.Goodridge Company.

Examples of polymeric gums which may be used as optional structurants herein can be characterized as marine plant, terrestrial plant, microbial polysaccharides and polysaccharide derivatives. Examples of marine plant gums include agar, alginates, carrageenan and furcellaran. Examples of terrestrial plant gums include guar gum, gum arabic, gum tragacenth, karaya gum, locust bean gum and pectin. Examples of microbial polysaccharides include dextran, gellan gum, rhamsan gum, welan gum and xanthan gum. Examples of polysaccharide derivatives include carboxymethyl cellulose, methyl hydroxypropyl cellulose, hydroxy propyl cellulose, hydroxyethyl cellulose, propylene glycol alginate and hydroxypropyl guar. Polymeric structurants are preferably selected from the above list or a combination thereof. Preferred polymeric gums include pectine, alginate, arabinogalactan (gum Arabic), carrageenan, gellan gum, xanthan gum and guar gum.

If polymeric gum structurant is employed herein, a preferred material of this type is gellan gum. Gellan gum is a tetrasaccharide repeat unit, containing glucose, glucurronic acid, glucose and rhamrose residues and is prepared by fermentation of Pseudomonaselodea ATCC 31461. Gellan gum is commercially marketed by CP Kelco U.S., Inc. under the KELCOGEL tradename. Processes for preparing gellan gum are described in U.S. Pat. Nos. 4,326,052; 4,326,053; 4,377,636 and 4,385,123.

H) Enzymes

The laundry detergent compositions herein may also optionally comprise one or more detersive enzymes. Suitable detersive enzymes for use herein include:

Proteases like subtilisins from Bacillus [e.g. subtilis, lentus, licheniformis, amyloliquefaciens (BPN, BPN′), alcalophilus,] e.g. Esperase®, Alcalase®, Everlase® and Savinase® (Novozymes), BLAP and variants [Henkel]. Further proteases are described in EP130756, WO91/06637, WO95/10591 and WO99/20726. Amylases (α and/or β) are described in WO 94/02597 and WO 96/23873. Commercial examples are Purafect Ox Am® [Genencor] and Termamyl®, Natalase®, Ban®, Fungamyl® and Duramyl® [all ex Novozymes]. Cellulases include bacterial or fungal cellulases, e.g. produced by Humicola insolens, particularly DSM 1800, e.g. 50 Kda and ˜43 kD [Carezyme®]. Also suitable cellulases are the EGIII cellulases from Trichoderma longibrachiatum. Suitable lipases include those produced by Pseudomonas and Chromobacter groups. Preferred are e.g. Lipolase®, Lipolase Ultra®, Lipoprime® and Lipex® from Novozymes. Also suitable are cutinases [EC 3.1.1.50] and esterases. Carbohydrases e.g. mannanase (U.S. Pat. No. 6,060,299), pectate lyase (WO99/27083) cyclomaltodextringlucanotransferase (WO96/33267) xyloglucanase (WO99/02663). Bleaching enzymes eventually with enhancers include e.g. peroxidases, laccases, oxygenases, (e.g. catechol 1,2 dioxygenase, lipoxygenase (WO 95/26393), (non-heme) haloperoxidases.

It is common practice to modify wild-type enzymes via protein/genetic engineering techniques in order to optimize their performance in the detergent compositions. If used, these enzymes are typically present at concentrations from 0.0001% to 2.0%, preferably from 0.0001% to 0.5%, and more preferably from 0.005% to 0.1%, by weight of pure enzyme (weight % of composition).

Enzymes can be stabilized using any known stabilizer system like calcium and/or magnesium compounds, boron compounds and substituted boric acids, aromatic borate esters, peptides and peptide derivatives, polyols, low molecular weight carboxylates, relatively hydrophobic organic compounds [e.g. certain esters, dialkyl glycol ethers, alcohols or alcohol alkoxylates], alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compound, polyamide oligomer, glycolic acid or its salts; poly hexamethylene bi guanide or N,N-bis-3-amino-propyl-dodecyl amine or salt; and combinations thereof.

I) Dye Transfer Inhibiting Agents

The laundry detergent compositions herein adjuncts may also optionally comprise one or more materials effective for inhibiting the transfer of dyes from one fabric to another. Generally, such dye transfer inhibiting agents include polyvinyl pyrrolidone polymers, polyamine N-oxide polymers, copolymers of N-vinylpyrrolidone and N-vinylimidazole, manganese phthalocyanine, peroxidases, and combinations thereof. If used, these agents typically are present at concentrations from 0.01% to 10%, preferably from 0.01% to 5%, and more preferably from 0.05% to 2%, by weight of the composition.

J) Optical Brighteners

The compositions herein may also optionally comprise from 0.01% to 2.0% by weight of an optical brightener. Suitable optical brighteners include stilbene brighteners. Stilbene brighteners are aromatic compounds with two aryl groups separated by an alkylene chain. Optical brighteners are described in greater detail in U.S. Pat. Nos. 4,309,316; 4,298,490; 5,035,825 and 5,776,878.

K) Suds Suppressors/Anti-Foam Agents

The compositions may comprise a suds suppressing system present at a level of from 0.01% to 15%, preferably from 0.1% to 5% by weight of the composition. Suitable suds suppressing systems for use herein may comprise any known antifoam compound, including silicone-based antifoam compounds and 2-alkyl alcanol antifoam compounds. Preferred silicone antifoam compounds are generally compounded with silica and include the siloxanes, particularly the polydimethylsiloxanes having trimethylsilyl end blocking units. Other suitable antifoam compounds include the monocarboxylic fatty acids and soluble salts thereof, which are described in U.S. Pat. No. 2,954,347. A preferred particulate suds suppressing system is described in EP-A-0210731. A preferred suds suppressing system in particulate form is described in EP-A-0210721.

L) Other Optional Composition Components

The present compositions may optionally comprise one or more additional composition components, such as liquid carriers, detergent builders and chelating agents including organic carboxylate builders such as citrate and fatty acid salts, stabilizers, coupling agents, fabric substantive perfumes, cationic nitrogen-containing detersive surfactants, pro-perfumes, bleaches, bleach activators, bleach catalysts, enzyme stabilizing systems, soil release polymers, dispersants or polymeric organic builders including water-soluble polyacrylates, acrylate/maleate copolymers and the like, dyes, colorants, filler salts such as sodium sulfate, hydrotropes such as toluenesulfonates, cumenesulfonates and naphthalenesulfonates, photoactivators, hydrolyzable surfactants, preservatives, anti-oxidants, anti-shrinkage agents, anti-wrinkle agents, germicides, fungicides, color speckles, colored beads, spheres or extrudates, sunscreens, fluorinated compounds, clays, pearlescent agents, luminescent agents or chemiluminescent agents, anti-corrosion and/or appliance protectant agents, alkalinity sources or other pH adjusting agents, solubilizing agents, carriers, processing aids, pigments, free radical scavengers, and pH control agents. Suitable materials include those described in U.S. Pat. Nos. 5,705,464, 5,710,115, 5,698,504, 5,695,679, 5,686,014 and 5,646,101.

M) Process for Preparing the Liquid Detergent Compositions

The liquid detergent compositions of the present invention can be prepared in any suitable manner and can, in general, involve any order of combining or addition as known by the person skilled in the art. As indicated, the miscible silicone blend is generally preformed and then added to the balance of the liquid detergent components.

When the preferred amino- and/or ammonium silicones are used as the functionalized silicone and when the second type of silicone in the blend is a non-functionalized polysiloxane, there is a preferred procedure for preparing such compositions which also forms part of the invention herein. As indicated hereinbefore in the Summary of the Invention, such a preparation method comprises the steps of providing the functionalized silicone having the selected characteristics described, combining this functionalized silicone component with non-functionalized silicones having the characteristics described to form a fully miscible blend of these two silicone types and then combining this silicone blend, preferably in the form of an emulsion, with the aqueous liquid detergent base formulation containing the indicated amounts of water, surfactant and aldehyde- and/or ketone-based fragrance compounds.

In this method, the functionalized silicones are preferably aminosilicones having a nitrogen content of from 0.001% to 0.5%, more preferably from 0.05% to 0.30% by weight, and a curable/reactive group content of not more than 0.3, more preferably not more than 0.1. The non-functionalized silicones blended therewith generally have a viscosity in the range of from 0.01 m²/s to 2 m²/s, more preferably form 0.05 m²/s to 1.0 m²/s. The miscible silicone blend is further preferably combined with water and at least one emulsifier and at least one silicone emulsion adjunct to thereby form an emulsion prior to its addition to the aqueous liquid base detergent composition.

The liquid base detergent composition will generally contain at least 4%, more preferably at least 20% of water; at least 5%, more preferably from 7% to 65% of surfactant; and from 0.00001% to 0.1%, more preferably from 0.001% to 0.05%, of the perfumery aldehydes and ketones. Generally all of the perfumery aldehydes and ketones will be present in the liquid detergent composition base when the silicone blend is combined therewith. None of these perfumery ingredients will be dissolved in the silicone blend or otherwise present in the silicone blend emulsion which is added to the liquid detergent base. Generally in the final detergent composition so formed, the droplets of the miscible silicone blend will have a mean particle size of no more than 200 microns, more preferably from 5 to 100 microns.

### EXAMPLES

The following non-limiting examples are illustrative of the present invention.

Several final liquid laundry detergent compositions (HDLs) are formulated by combining a pre-formed silicone blend, which is emulsified with an emulsifier, with a fabric cleaning premix containing at least one textile cleaning surfactant and at least one perfume material in the form of an aldehyde and/or ketone and a number of additional conventional HDL ingredients and adjuncts.

Fabric cleaning premixes A1 and A2 and A3 and A4:

| | wt % | | | |
|---|---|---|---|---|
| | (raw materials at 100% activity) | | | |
| | A1 | A2 | A3 | A4 |
| C₁₃-C₁₅ alkylbenzene sulphonic | 13.0 | 5.5 | 5.5 | 1.0 |
| acid | | | | |
| C₁₂-C₁₅ alkyl ethoxy (1.1 eq.) | | 13.0 | 13.0 | — |
| sulphate | | | | |
| C₁₂-C₁₅ alkyl ethoxy (1.8 eq.) | | | | 13.0 |
| sulphate | | | | |
| C₁₄-C₁₅ EO8 (1) | 9.0 | — | — | — |
| C₁₂-C₁₃ EO9 (2) | — | 2.0 | 2.0 | 2.0 |
| C₁₂-C₁₄ alkyl dimethyl amineoxide | 1.5 | 1.0 | 1.0 | — |
| (3) | | | | |
| C₁₂ alkyl trimethyl ammonium | | | | 1.0 |
| chloride | | | | |
| C₁₂-C₁₈ fatty acid | 10.0 | 2.0 | 2.0 | 1.0 |
| Citric acid | 4.0 | 4.0 | 4.0 | 2.0 |
| Diethylene triamine pentamethylene | 0.3 | — | — | — |
| phosphonic acid | | | | |
| Hydroxyethane dimethylene | 0.1 | — | — | — |
| phosphonic acid | | | | |
| Ethoxylated polyethylene imine | 1.0 | 1.0 | 1.0 | 0.5 |
| Ethoxylated tetraethylene pentamine | 1.0 | 0.5 | 0.5 | 0.3 |
| Di Ethylene Triamine Penta acetic | — | 0.5 | 0.5 | 0.1 |
| acid | | | | |
| Ethoxysulphated hexamethylene | — | 1.0 | 1.0 | 0.7 |
| diamine quat | | | | |
| Fluorescent whitening agent | 0.15 | 0.15 | 0.15 | 0.1 |
| CaCl₂ | 0.02 | 0.02 | 0.02 | — |
| Propanediol | 5.0 | 3.5 | 6.5 | 5.0 |
| Diethylene Glycol | — | 3.0 | — | — |
| Ethanol | 2.0 | 2.0 | 2.0 | 2.0 |
| Sodium cumene sulphonate | 2.0 | — | — | 1.0 |
| Monoethanolamine | | | | 2.0 |
| NaOH | to pH | to pH | to pH | to pH |
| | 7.8 | 8.0 | 8.0 | 8.2 |
| Protease enzyme | 0.75 | 0.75 | 0.75 | 0.3 |
| Amylase enzyme | 0.20 | 0.20 | 0.20 | — |
| Cellulase enzyme | 0.05 | — | — | — |
| Boric acid | 2.0 | 0.3 | — | 1.0 |
| Na-Borate | — | — | 1.5 | — |
| Poly(N-vinyl-2-pyrrolidone)-poly(N- | 0.1 | — | — | — |
| vinyl-imidazol) (MW: 35,000) | | | | |
| Cationic Cellulose Ether (4) | — | — | 0.15 | — |
| Gellan Gum (5) | — | 0.2 | — | — |
| Hydrogenated castor oil | 0.2 | — | 0.3 | 0.2 |
| Dye | 0.001 | 0.001 | 0.001 | 0.01 |
| Perfume (6) | 0.70 | 0.70 | 0.70 | 0.5 |
| Water | Bal- | Bal- | Bal- | Bal- |
| | ance | ance | ance | ance |

(1) Marlipal 1415/8.1 ex Sasol
(2) Neodol 23-9 ex Shell
(3) C₁₂-C₁₄ alkyl dimethyl amineoxide ex P&G, supplied as a 31% active solution in water
(4) JR400 ex Dow Chemical - Falls within cationic cellulose structural formula hereinbefore set forth. Hydrophobically modified and swollen with water prior to addition to the premix.
(5) Kelcogel LT100 ex CP Kelco U.S., Inc.
(6) Multicomponent perfume composition comprising 60% by weight of aldehydes and ketones

Preparation of Amino-Polysiloxane for the Silicone Blend
1) Preparation of Precursor High in Amino Groups

1,003.3 g (3.86 mol) of aminoethylaminopropylmethyldimethoxysilane, 1,968 g of a siloxane of the composition M2D25 and 29.7 g of a 10% strength solution of KOH in methanol are mixed with one another in a four-necked flask at room temperature, while stirring. 139 g (7.72 mol) of deionized water are added dropwise to the cloudy mixture, and the temperature rises to 46° C. The temperature is increased stepwise to 125° C. in the course of 3 hours, with a methanol-containing distillate (363 g) being removed from 80° C. After cooling back to 116° C., 139 g of water are again added and the temperature is subsequently increased to 150° C. in the course of 3 hours, with 238 g of distillate being obtained. After renewed cooling back to 110° C., addition of 139 g of water and heating to 150° C. in the course of 3 hours, 259 g of distillate are obtained. Finally, the constituents which boil up to 150° C. under an oil vacuum are removed (123 g). 2,383 g of a yellow, clear oil are obtained.

The product obtained is analyzed for reactive group content using NMR spectroscopy methods. Such methods involve the following parameters:
1) Instrument Type: Bruker DPX400 NMR spectrometer
2) Frequency: 400 MHz
3) Standard: Tetramethylsilane (TMS)
4) Solvent: CDCl₃ (deuterated chloroform)
5) Concentration: for H-1 0.2%; for Si-29 20%
6 Pulse Sequence: ZGIZ™ (Bruker) for Si-29-nmr spectra with 10 second relaxation delay time

Using NMR having these characteristics, the following analysis is obtained:
M_{1.95}D^{OH}_{0.025}D^{OCH3}_{0.025}D*_{7.97}D_{36.9}
where D*=SiCH₂CH₂CH₂NHCH₂CH₂NH₂.
2) Preparation of Aminosilicone with Low Reactive/Curable Group Content

200.6 g (47.7 mmol) of the precursor high in amino groups as prepared in Step 1); 101 g (152.3 mmol) of a siloxane of the composition M2D6.9, 6,321 g of D4 and 1.66 g of 10% strength KOH in ethanol are initially introduced into a four-necked flask at room temperature, while stirring, and the mixture is heated at 180° C. for 3 hours. After cooling back to 120° C., a further 1.66 g of 10% strength KOH in ethanol are added. The mixture is then heated at 180° C. for a further 3 hours (the viscosity of a sample taken at this point in time is 2,940 mPas, 20° C.). A water-pump vacuum is applied at 180° C., so that D4 boils under reflux for 10 minutes. 60 g of D4, which contains included drops of water, are removed in a water separator. This procedure is repeated after 2, 4 and 6 hours. After cooling back to 30° C., 0.36 g of acetic acid is added to neutralize the catalyst. All the constituents which boil up to 150° C. are then removed under an oil vacuum. 5,957 g of a colorless aminosiloxane with a viscosity of 4,470 mPas (20° C.) and the composition, determined by NMR spectroscopy as described above, of
M₂D*_{2.16}D₄₄₇
where D*=SiCH₂CH₂CH₂NHCH₂CH₂NH₂ are obtained. Such a material has a nitrogen content of 0.20% by weight and a percent ratio of terminal curable/reactive groups of essentially 0%.

Preparation of the silicone emulsion (Emulsion E1): 15.0 g of the Step 2 aminosilicone are added to 45.0 g of PDMS 0.6 m/s² (600,000 centistokes at 20° C.; GE® Visc-600M) and mixed with a normal laboratory blade mixer (type: IKA Labortechnik Eurostar power control-visc lab mixer) for at least 1 hour.

14.3 g of the blend of Step 2 aminosilicone with PDMS 0.6 m/s² are added to 7.15 g of Neodol 25-3 ex Shell (ethoxylated alcohol nonionic emuslifier) and the mixture is stirred for 15 minutes with a normal laboratory blade mixer (type: IKA Labortechnik Eurostar power control-visc lab mixer) at 250 RPM.

3 equal partitions of 7.14 g water are added with each time 10 minutes stirring at 250 RPM in-between.

A final 7.14 g water is added and the stirring speed is increased to 400 RPM. The mixture is stirred at this speed for 40 minutes.

Preparation of the silicone emulsion (Emulsion E2): 15.0 g of the Step 2 aminosilicone are added to 45.0 g of PDMS 0.6 m/s² (600,000 centistokes at 20° C.; GE® Visc-600M) and mixed with a normal laboratory blade mixer (type: IKA Labortechnik Eurostar power control-visc lab mixer) for at least 1 hour.

30.0 g of the blend of Step 2 aminosilicone with PDMS 0.6 m/s² are added to 4.30 g of Crill 4 sorbitan oleate ex Croda and mixed with a normal laboratory blade mixer at 300 RPM for 15 minutes.

11.6 g of Crodet S100 PEG-100 stearate (25% in water) ex Croda are added and the mixture is stirred for 15 minutes at 1000 RPM.

5.1 g water is added dropwise in a time span of 10 minutes, upon stirring at 1000 RPM, and after the addition of the water, the mixture is stirred for another 30 minutes at 1000 RPM.

27.0 g of a 1.45% sodium carboxymethyl cellulose solution are added and the mixture is stirred for 15 minutes at 500 RPM.

Preparation of the silicone emulsion (Emulsion E3): 15.0 g of the Step 2 aminosilicone are added to 45.0 g of PDMS 0.1 m/s² (100,000 centistokes at 20° C.; GE® Visc-100M) and mixed with a normal laboratory blade mixer (type: IKA Labortechnik Eurostar power control-visc lab mixer) for at least 1 hour.

19.25 g of of the blend of Step 2 aminosilicone with PDMS 0.1 m/s² is mixed with 1.15 g of Neodol 25-3 ex Shell and 4.6 g of Slovasol 458 ex Sasol (ethoxylated alcohol nonionic) and stirred for 10 minutes at 300 RPM.

10.0 g water is added and the mixture is stirred for 30 minutes at 300 RPM.

3 equal partitions of 5.0 g water are added, with 10 minutes stirring at 300 RPM after each water addition.

Preparation of the silicone emulsion (Emulsion E4): 6.0 g of the Step 2 aminosilicone are added to 54.0 g of PDMS 0.6 m/s² (600,000 centistokes at 20° C.; GE® Visc-600M) and mixed with a normal laboratory blade mixer (type: IKA Labortechnik Eurostar power control-visc lab mixer) for at least 1 hour.

19.25 g of of the blend of Step 2 aminosilicone with PDMS 0.6 m/s² is mixed with 4.6 g of Neodol 25-3 ex Shell and 1.15 g of Slovasol 458 ex Sasol and stirred for 10 minutes at 300 RPM.

10.0 g water is added and the mixture is stirred for 30 minutes at 300 RPM.

3 equal partitions of 5.0 g water are added, with 10 minutes stirring at 300 RPM after each water addition.

Preparation of the silicone emulsion (Emulsion E5): 15.0 g of the Step 2 aminosilicone are added to 45.0 g of PDMS 0.1 m/s² (100,000 centistokes at 20° C.; GE® Visc-100M) and mixed with a normal laboratory blade mixer (type: IKA Labortechnik Eurostar power control-visc lab mixer) for at least 1 hour.

30.0 g of the blend of Step 2 aminosilicone with PDMS 0.1 m/s² are added to 4.30 g of Crill 4 sorbitan oleate ex Croda and mixed with a normal laboratory blade mixer at 300 RPM for 15 minutes.

11.6 g of Crodet S100 PEG-100 stearate (25% in water) ex Croda are added and the mixture is stirred for 15 minutes at 1000 RPM.

5.1 g water is added dropwise in a time span of 10 minutes, upon stirring at 1000 RPM, and after the addition of the water, the mixture is stirred for another 30 minutes at 1000 RPM.

27.0 g of a 1.45% sodium carboxymethyl cellulose solution are added and the mixture is stirred for 15 minutes at 500 RPM

Final Detergent Compositions (HDLs)—Formed by Combining Two (A and E) Premixes

A1 & E1 (HDL 1) or A1 & E2 (HDL 2) or A1 & E3 (HDL 3) or A1 & E4 (HDL 4) or A1 & E5 (HDL 5) or A2 & E1 (HDL 6) or A2 & E2 (HDL 7) or A2 & E3 (HDL 8) or A2 & E4 (HDL 9) or A2 and E5 (HDL 10) or A3 & E1 (HDL 11) or A3 & E2 (HDL 12) or A3 & E3 (HDL 13) or A3 & E4 (HDL 14) or A3 & E5 (HDL 15) or A4 & E1 (HDL 16) or A4 & E2 (HDL 17) or A4 & E3 (HDL 18) or A4 & E4 (HDL 19) or A4 & E5 (HDL 20)

104.9 g of premix E1 is added to 1500 g of either premixes A1 or A2 or A3 or A4 and stirred for 15 min at 350 RPM with a normal laboratory blade mixer.

78.0 g of premix E2 or E3 or E4 or E5 is added to 1500 g of either premixes A1 or A2 or A3 or A4 and stirred for 15 min at 350 RPM with a normal laboratory blade mixer.

For all emulsions E1, E2, E3, E4 and E5, the mean particle size of silicone droplets in the products formed by combining these emulsions with the A1, A2, A3 or A4 products is in the 2 μm-20 μm range.

The liquid laundry detergent compositions of HDLs 1 to 20 all demonstrate excellent product stability as fully formulated composition as well as in diluted form during a laundering cycle. The liquid laundry detergent compositions of HDLs 1 to 20 all provide excellent fabric cleaning and fabric care performance when added to the drum of an automatic washing machine with fabrics which are laundered therein in conventional manner.

The compositions of HDLs 1 to 20 are particularly advantageous with respect to fabric softening benefits imparted to fabrics treated therewith; this is especially true for colored fabrics on which the observed fabric softening benefits are even more enhanced in comparison to the fabric softening benefits provided onto white fabrics. The compositions of HDLs 1-5 and 11-15 are also advantageous with respect to anti-abrasion benefits and to anti-pilling benefits provided for fabrics treated therewith. The compositions of HDLs 1-5 are particularly advantageous with respect to color care benefits imparted to fabrics treated therewith.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An aqueous liquid laundry detergent composition comprising at least about 4% water and suitable for cleaning and imparting fabric care benefits to textiles, which composition comprises:
A) at least about 5%, by weight of the detergent composition, of textile cleaning surfactants,
B) at least about 0.01%, by weight of the detergent composition, of silicone droplets of silicones miscible at weight ratios of from about 1:100 to about 100:1 comprising:
(i) a flowable unfunctionalized or non-polarly functionalized silicone and
(ii) a polarly functionalized silicone;
C) a perfume comprising a fragrant aldehyde, ketone or mixture thereof or a pro-perfume compound capable of providing in-situ in the detergent said fragrant aldehyde, ketone or mixture thereof, and
D) optionally a thickener or structurant for the aqueous phase.

2. An aqueous liquid laundry detergent composition according to claim 1 wherein said miscible silicones are in a blend which comprises:
i) an amine or ammonium group-containing polarly-functionalized polysiloxane material which:
a) has been prepared by a process which intrinsically leaves curable/reactive groups in the polarly-functionalized polysiloxane material;
b) has a molar ratio of curable/reactive group-containing silicone atoms to terminal silicone atoms containing no reactive/curable groups which is less than about 30%;
c) has a nitrogen content of from about 0.05% to about 0.30%, by weight of the blend; and
d) has viscosity at 20° C. ranging from about 0.00002 m²/s to about 0.2 m²/s; and
ii) a nitrogen-free, non-functionalized polysiloxane material having a viscosity of from about 0.01 m²/s to about 2.0 m²/s and present in an amount such that within said blend the weight ratio of polarly-functionalized polysiloxane material to non-functionalized polysiloxane material ranges from about 100:1 to about 1:100.

3. A liquid laundry detergent composition according to claim 1 wherein said polarly-functionalized polysiloxane material has been prepared by a process which comprises hydrolysis of nitrogen-containing alkoxysilane and/or alkoxysiloxane starting materials and catalytic equilibration and condensation of these hydrolyzed starting materials; and has a molar ratio of curable/reactive group-containing silicon atoms to terminal silicon atoms containing no reactive/curable groups which is less than about 20%.

4. A liquid detergent composition according to claim 1 wherein said polarly-functionalized polysiloxane material has a molar ratio of hydroxyl- and/or alkoxy-containing silicon atoms to terminal silicon atoms containing no hydroxyl or alkoxy groups which is less than about 1.0%.

5. A liquid laundry detergent composition according to claim 1 wherein said polarly-functionalized polysiloxane has a molecular weight ranging from about 2,000 to about 100,000.

6. A liquid laundry detergent composition according to any of claim 2 wherein the weight ratio of polarly-functionalized polysiloxane to non-functionalized polysiloxane within said silicone blend ranges from about 1:20 to about 1:1.

7. A liquid laundry detergent composition according to claim 2 wherein said silicone blend is combined with an emulsifier and water and preformed into an oil-in-water emulsion suitable for addition as a separate component of the detergent composition.

8. A liquid laundry detergent composition according to claim 7 wherein within said emulsion contains from about 5% to about 60%, by weight of the emulsion, of said silicone blend.

9. A liquid laundry detergent composition according to claim 7 wherein within said emulsion the weight ratio of silicone blend to emulsifier ranges from about 200:1 to about 1:1 and the weight ratio of silicone blend to water ranges from about 1:50 to about 10:1.

10. A liquid laundry detergent composition according to claim 7 wherein the emulsifier used to form said emulsion is selected from alcohol ethoxylates, alkyl polyglucosides, ethoxylated and non-ethoxylated sorbitan esters, ethoxylated and non-ethoxylated fatty acid esters, ethoxylated and non-ethoxylated fatty amines and amides, ethoxylated glycerol esters, polyalkoxylated polysiloxanes and C₁₂₋₁₅ alkyl trimethylammonium salts and their hydroxyalkyl-substituted and ester group-containing analogs.

11. A liquid laundry detergent composition according to claim 1 wherein the droplets of miscible silicones within said composition range in median particle size from about 0.5 to about 300 microns.

12. A liquid laundry detergent composition according to claim 2 wherein said polarly-functionalized polysiloxane within said silicone blend comprises an amino-polysiloxane having the formula: 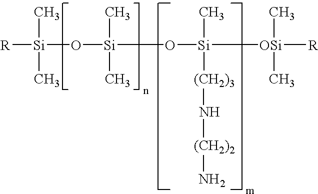
wherein R is independently selected from C₁ to C₄ alkyl, hydroxyalkyl and combinations thereof, and wherein n is a number from about 49 to about 1299; m is an integer from about 1 to about 50; the sum of n and m is a number from about 50 to about 1300.

13. A liquid laundry detergent composition according to claim 10 wherein said amino-polysiloxane has a nitrogen content of from about 0.10% to about 0.25%, by weight of the amino polysiloxane, and has a viscosity of from about 0.001 m²/s to about 0.1 m²/s.

14. A liquid laundry detergent composition according to claim 1 wherein said detergent composition comprises a coacervate-forming polymer and/or a cationic deposition aid.

15. A liquid laundry detergent composition according to claim 14 wherein the cationic deposition aid is selected from the group consisting of cationic cellulose and derivatives thereof, cationic starch and derivatives thereof and cationic guar gum and derivatives thereof.

16. A liquid laundry detergent composition according to claim 1 wherein said detergent composition comprises a structurant.

17. A liquid laundry detergent composition according to claim 16 wherein said structurant is selected from the group consisting of hydrogenated castor oil and wax, pectine, alginate, gum Arabic, carrageenan, gellan gum, xanthan gum, guar gum and combinations of said structurants.

18. A liquid laundry detergent composition according to claim 1 wherein said non-functionalized polysiloxane is polydimethylsiloxane and has a viscosity ranging from about 0.5 m²/s to about 1.0 m²/s.

19. An aqueous liquid laundry detergent composition suitable for cleaning and imparting fabric care benefits to fabrics laundered using such a composition, which composition comprises at least about 4%, by weight of the composition, of water and:
A) at least about 5%, by weight of the composition, of at least one surfactant selected from the group consisting of anionic surfactants, nonionic surfactants, zwitterionic surfactants, amphoteric surfactants, and combinations thereof;
B) from about 0.01% to about 10%, by weight of the composition, of droplets of a blend of highly miscible silicone materials, which blend comprises:
an amine or ammonium group-containing functionalized polysiloxane material having nitrogen content in the range from about 0.001% to about 0.5% and a curable-reactive group content, expressed as a molar ratio of curable-reactive group containing silicone atoms to terminal silicone atoms containing no curable-reactive groups, of not more than about 0.3;
a nitrogen-free, non-functionalized polysiloxane material having a viscosity of from about 0.01 m²/s to about 2.0 m²/s and present in an amount such that within said blend the weight ratio of functionalized polysiloxane material to non-functionalized polysiloxane material ranges from about 1:15 to about 1:2;
C) from about 0.00001 to about 0.1%, by weight of the composition, of fragrant compounds selected from perfumery aldehydes, ketones, and mixtures thereof; and
D) at least about 0.1%, by weight of the composition, of liquid laundry detergent adjuncts selected from one or more of:
i) from about 1% to about 80%, by weight of the laundry detergent adjunct, of a detergent builder, chelant or mixture thereof;
ii) from about 0.0001% to about 2%, by weight of the laundry detergent adjunct, of a detersive enzyme component;
iii) from about 0.01% to about 10%, by weight of the laundry detergent adjunct, of a dye transfer agent;
iv) from about 0.0001% to about 1%, by weight of the laundry detergent adjunct, of a pre-compounded silicone/silica antifoam agent;
v) from about 0.00001% to about 0.5%%, by weight of the laundry detergent adjunct, of a non-staining dye or pigment; and
vi) from about 0.000001% to about 0.2% of an optical brightener.

20. A liquid laundry detergent composition according to claim 1 wherein said perfumery aldehydes are selected from one or more of: hexyl aldehyde, heptyl aldehyde, octyl aldehdyde, nonyl aldehyde, 3,5,5-trimethyl hexanal, decyl aldehyde, undecyl aldehyde, dodecyl aldehyde, nonenal, decenal (decenal-4-trans), undecenal (aldehyde iso C11, 10-Undecenal), nonadienal, 2,6,10-trimethyl-9-undecenal, 2-methylundecanal, geranial, neral, citronellal, dihydrocitronellal, 2,4-dimethyl-3-cyclohexene-1-carboxaldehyde, 2-methyl-3-(4-isopropylphenyl)propanal, 2-methyl-3-(4-tert.-butylphenyl)propanal, 2-methyl-3-(4-(2-methylpropyl)phenyl)propanal, anisic aldehyde, cetonal, 3-(3-isopropylphenyl)butanal, 2,6-dimethyl-heptenal, 4-methyphenylacetaldehyde, 1-methyl-4(4-methylpentyl)-3-cyclohexene-carbaldehyde, butyl cinnamic aldehyde, amyl cinnamic aldehyde, hexyl cinnamic aldehyde, 4-methyl-alpha-pentyl cinnamic aldehyde, alpha-2,2,3-tetramethyl-3-cyclopentene-1-butyraldehyde (santafleur), isohexenyl tetrahydro benzaldehyde, citronellyl oxyacetaldehyde, melafleur, lyral, 2-methyl-3 (para-methoxy phenyl)-propanal, cyclemone A, para-ethyl-alpha,alpha-dimethyl hydrocinnamaldehyde, dimethyl decadienal, alpah-methyl-3,4-(methylenedoxy) hydrocinnamaldehyde, isocyclocitral, methyl cinnamic aldehyde, methyl octyl aldehyde; and wherein said perfumery ketones are selected from one or more of: alpha-damascone, beta-damascone, delta-damascone, damascenone, dihydro ionone beta, geranyl acetone, benzyl acetone, beta ionone, alpha ionone, gamma methyl ionone, methyl heptenone, 2-(2-(4-methyl-3-cyclohexen-1-yl)propyl)cyclopentanone, 5-cyclohexadecen-1-one, 6,7-dihydro-1,1,2,3,3,-pentamethyl-4(5H)-indanone, heptyl cyclopentanone, hexyl cyclopentanone, 7-acetyl, 1,2,3,4,5,6,7,8-octahydro-1,1,6,7-tetramethyl naphthalene, isocyclemone E, methyl cedryl ketone, methyl dihydrojasmonate.

21. A liquid laundry detergent composition according to claim 1 wherein said composition comprises from about 1% to about 10%, by weight of the composition, of an ancillary quaternary ammonium fabric-softening agent having the formula 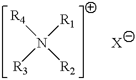
wherein R₁ and R₂ are individually selected from the group consisting of C₁-C₄ alkyl, C₁-C₄ hydroxy alkyl, benzyl, and —(C₂H₄O)ₓH where x has a value from about 2 to about 5; X is an anion; and (1) R₃ and R₄ are each a C₈-C₁₄ alkyl or (2) R₃ is a C₈-C₂₂ alkyl and R₄ is selected from the group consisting of C₁-C₁₀ alkyl, C₁-C₁₀ hydroxy alkyl, benzyl, and —(C₂H₄O)_{X}H where x has a value from about 2 to about 5.

22. A method for preparing an aqueous liquid detergent comprising (a) fragrant compounds selected from perfumery aldehydes and ketones and (b) fabric care actives comprising silicones having functional groups that react therewith; said method comprising:
I) providing functional silicone materials selected from aminosilicones, ammonium functional silicones, substituted ammonium functional silicones and mixtures thereof wherein said functional silicones are miscible with non-functional silicones by virtue of said functional silicones having a nitrogen content in the range from about 0.001 to about 0.5% percent by weight of said functional silicones; said functional silicones having a molar ratio of curable/reactive group containing silicon atoms to terminal silicone atoms containing no curable/reactive groups of not more than about 0.3;
II) blending said functional silicones with non-functional polysiloxane materials that are fully miscible therewith and have viscosity in the range from about 0.01 to about 2 m²/s, optionally in the presence of at least one emulsifier and optionally with one or more silicone emulsion adjuncts; and
III) combining the product of step (II) with an aqueous liquid detergent base formulation comprising at least about 4%, by weight of the aqueous liquid detergent base, of water, at least about 5%, by weight of the aqueous liquid detergent base, of a surfactant and said fragrant compounds selected from perfumery aldehydes and ketones at a level of from about 0.00001 to about 0.1%, by weight of the aqueous liquid detergent base, such that the final composition comprises discrete droplets of the miscible silicones having a mean particle size of no more than about 200 microns.

23. An aqueous liquid laundry detergent having fabric care benefits and stability of the silicones and of said perfumery aldehydes and ketones, comprising the product of a preparation method according to claim 22.

24. An aqueous liquid laundry detergent composition comprising at least about 4%, by weight of the aqueous detergent composition, of water in an aqueous phase and suitable for cleaning and imparting fabric care benefits to textiles, wherein the aqueous detergent composition comprises:
A) at least about 5%, by weight of the aqueous detergent composition of textile cleaning surfactants,
B) at least about 0.01%, by weight of the aqueous detergent composition, of silicone droplets of silicones miscible at weight ratios of from about 1:100 to about 100:1 comprising:
(i) a flowable unfunctionalized or non-polarly functionalized silicone and
(ii) a polarly functionalized silicone;
C) from about 1% to about 10%, by weight of the aqueous detergent compostion, of a quaternary ammonium fabric-softening agent having the formula 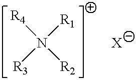
wherein R₁ and R₂ are individually selected from the group consisting of C₁-C₄ alkyl, C₁-C₄ hydroxy alkyl, benzyl, and —(C₂H₄O)_{X}H where x has a value from about 2 to about 5; X is an anion; and (1) R₃ and R₄ are each a C₈-C₁₄ alkyl or (2) R₃ is a C₈-C₂₂ alkyl and R₄ is selected from the group consisting of C₁-C₁₀ alkyl, C₁-C₁₀ hydroxy alkyl, benzyl, and —(C₂H₄O)ₓH where x has a value from about 2 to about 5;
D) optionally a perfume comprising a fragrant aldehyde, ketone or mixture thereof or a pro-perfume compound capable of providing in-situ in the detergent said fragrant aldehyde, ketone or mixture thereof,
E) optionally a thickener or structurant for the aqueous phase; and
F) optionally, a coacervating agent, a deposition aid or a mixture thereof.

25. A liquid laundry detergent composition according to claim 24 wherein said composition contains a cationic deposition aid selected from the group consisting of cationic cellulose and derivatives thereof, cationic starch and derivatives thereof and cationic guar gum and derivatives thereof.

26. A liquid laundry detergent composition according to claim 24 which contains a structurant.

27. A liquid laundry detergent composition according to claim 26 wherein said structurant is selected from the group consisting of hydrogenated castor oil and wax, pectine, alginate, gum Arabic, carrageenan, gellan gum, xanthan gum, guar gum and combinations of said structurants.
